(19) United States
(12) Patent Application Publication
(10) Pub. No.: US 2006/0287617 A1
(43) Pub. Date: Dec. 21, 2006

(54) AUTOCITE WORKSTATION AND SYSTEMS AND METHODS THEREFOR

(75) Inventors: Edward Taub, Birmingham, AL (US); Peter S. Lum, Clarksburg, MD (US)

Correspondence Address: JENKENS & GILCHRIST, 1401 MCKINNEY, SUITE 2600, HOUSTON, TX, 77010, US

(73) Assignee: DEPARTMENT OF VETERANS AFFAIRS

(21) Appl. No.: 11/425,105

(22) Filed: Jun. 19, 2006

Related U.S. Application Data
(60) Provisional application No. 60/692,331, filed on Jun. 20, 2005.

(51) Int. Cl. A61H 1/02

(52) U.S. Cl. 601/24

(57) ABSTRACT

Automated constraint-induced therapy extension (AutoCITE) workstation and systems and methods therefor. Use of the AutoCITE workstation (and associated systems and methods) allows constraint-induced movement therapy (CI therapy) to be extended to certain patients who have suffered a stroke, traumatic brain injury, brain resection, Multiple Sclerosis or spinal cord injury and for whom continuous one-on-one supervision by a therapist is not practicable or financially feasible. Use of the AutoCITE workstation (and associated systems and methods) further allows a tele-rehabilitation approach that is based directly on CI therapy to be implemented.

### CROSS-REFERENCE TO RELATED APPLICATIONS

This application claims priority to, and hereby incorporates by reference in its entirety, U.S. patent application Ser. No. 60/692,331 entitled “Automated constraint-induced therapy extension (autocite)” by Edward Taub and Peter S. Lum, filed Jun. 20, 2005.

### TECHNICAL FIELD

The disclosed embodiments relate generally to a workstation (and associated systems and methods) for automated constraint-induced movement therapy (i.e., automated CI therapy). “Automated CI Therapy Extension” (abbreviated “AutoCITE”) is used to designate embodiments. In particular, disclosed embodiments allow CI therapy to be extended to certain patients who have suffered a stroke, traumatic brain injury (TBI), brain resection, Multiple Sclerosis or spinal cord injury (SCI) and for whom continuous one-on-one supervision by a therapist is not practicable or financially feasible.

### BACKGROUND

Stroke or cerebrovascular accident (CVA) is the leading cause of adult disability in the United States. Every year about 700,000 people in the United States suffer a CVA, and, of these 700,000 people, more than 150,000 die as a result. In 2006, the direct and indirect costs in the United States of stroke are expected to total to an estimated $57.9 billion. Of this total, more than ten percent of the costs are expected to correspond to lost productivity costs attributable to motor disability. Among CVA survivors (i.e., a population now estimated in the United States to be greater than three million), more than half are left with motor disability.

With the demographic shift towards an aging population in the United States, the population at risk for a CVA will increase sharply in this century. Because large subpopulations of veterans are in age ranges in which CVAs commonly occur, CVAs are a particular challenge for the Department of Veterans Affairs (VA). In fiscal year 1997, for example, the national VA system had 22,000 admissions for acute CVA. The expenditures on the part of the Federal Government in general (and the VA in particular) that are required to provide care for and to treat veterans who suffer CVAs (and who sustain associated motor deficits) are also very large.

Despite a substantial and long-felt need, the number of empirically validated, rehabilitative types of treatment for CVA-related motor disabilities is relatively small. However, Constraint-Induced Movement therapy (or CI therapy) represents a treatment type that includes a family of related techniques for which empirical validation of rehabilitative efficacy is available.

Controlled, randomized studies have indicated that CI therapy can substantially reduce motor deficits for more-affected limbs of many patients with chronic CVAs. Furthermore, CI therapy does not involve medications, and there are no significant deleterious side effects or risks. In a recently completed multi-site, randomized clinical trial of CI therapy, outcomes for patients receiving CI therapy were significantly superior to outcomes for control group patients who received usual, customary care. Such multi-site randomized trials are considered the “gold-standard” in medical research. No other such trial has been carried out in the field of stroke rehabilitation. Moreover, the beneficial therapeutic effects of CI therapy have been demonstrated to transfer from the clinic to the real world. Patients show increases in the daily use of their more impaired limbs that are maintained, after interventions applying more powerful variants of CI therapy, beyond two years after treatment. In addition to being used to enhance motor recovery in patients with CVA, the CI therapy approach can be used to enhance motor recovery in patients with TBI, brain resection, Multiple Sclerosis or SCI.

Typically a very large difference often exists between what a chronic stroke patient can do and what he or she does (e.g., in activities of daily living, or ADLs). CI therapy has been shown to be particularly helpful in reducing this difference. In particular, the difference between the true motor capacity of a chronic stroke patient and his or her actual use of an affected limb may, in many instances, be attributable to a learned nonuse that develops in the early poststroke period. CI therapy is especially helpful for overcoming this learned nonuse. Cortical reorganization may be associated with this effect of CI therapy. In several studies, CI therapy has been shown to produce a large, use-dependent increase in the amount of brain recruited to produce movements of an affected arm in humans with stroke-related hemiparesis of an upper extremity.

For upper limbs, standard CI therapy involves inducing the use of the more-affected limb by employing one of several methods for restraining or reducing use of the less affected limb for two or three weeks. Though the words “constraint induced” (abbreviated “CI”) are used to label this therapy, there is nothing talismanic about the use of a sling or other movement restriction device to constrain the less-affected limb. “CI” therapy for lower limbs, for example, may include massed or repetitive practice of lower limb tasks wherein neither lower limb is restrained (e.g., in tasks of treadmill walking or over-ground walking). That is, the key component of CI therapy, at least for its efficaciousness, is the concentrated, repetitive training of the more-affected limb. In standard CI therapy, this concentrated, repetitive training (i.e., massed practice) of the more-affected limb is often given daily for six hours, interspersed with one hour of rest, for each of the weekdays over a two- or three-week period. Repetitive training of the more-affected limb for only three hours daily over ten consecutive weekdays has been found significantly to improve motor function in chronic hemiparesis patients, although in some cases, repetitive training of the more-affected limb for only three hours daily over ten consecutive weekdays may be less effective than repetitive training for six hours daily.

Taub and colleagues further enhanced motor recovery in chronic CVA patients by adding shaping procedures (in which a desired motor or behavioral objective is encouraged in small steps by successive approximations) to massed practice with the more-affected limb (and with the less-affected limb being restrained). They treated chronic stroke patients (N=4) with CI therapy wherein the CI therapy included largely continuous therapist-supervised shaping. As compared to an attention-placebo control group (N=5), the treatment group demonstrated a significant increase in motor ability and a very large increase in real-world use of the affected arm.

For inclusion in early clinical studies of CI therapy, CVA patients typically were required to meet or exceed, among other criteria, a minimum motor criterion of being capable of twenty-degree extension of the wrist and ten-degree extension of each finger. Only the first quartile of the chronic CVA population with residual motor deficit likely meet this minimum motor criterion. Subsequent studies have suggested that CI therapy is applicable to up to 75 percent of the CVA population with chronic unilateral motor deficit, although the inclusion of shaping procedures to train arm function may be more important for efficaciously treating lower functioning patients than first quartile patients. In other words, with the inclusion of shaping procedures, several hundred thousand or more chronic CVA patients (including lower functioning patients, as well as patients with TBI, brain resection, Multiple Sclerosis or SCI) could realize substantial improvements in motor function through CI therapy.

TABLE 1
Select Abbreviations

| | |
|---|---|
| ADL | activity of daily living |
| ANOVA | analysis of variance |
| AOU | amount of use |
| CVA | cerebrovascular accident (or “cerebral vascular accident”) |
| CI | constraint-induced (or “constraint induced movement”) |
| ISP | Internet service provider |
| MAL | Motor Activity Log |
| MCID | minimal clinically important difference |
| QOM | quality of movement |
| SCI | spinal cord injury |
| SD | standard deviation |
| TBI | traumatic brain injury |
| VA | Department of Veterans Affairs |
| VR | virtual reality |
| WMFT | Wolf Motor Function Test |

### SUMMARY

AutoCITE (Automated CI Therapy Extension) embodiments automate the training portion of CI therapy, which includes repetitive tasks, and, in some embodiments, may additionally include shaping protocols. Some AutoCITE embodiments (and particularly embodiments that include shaping protocols) may be as efficacious for patients as standard CI therapy. The use of some AutoCITE embodiments may reduce the cost of CI therapy by allowing participants to perform AutoCITE training largely by themselves (i.e., either without therapist supervision, or with therapist supervision that variously is not continuous, is provided from a remote location, or both is not continuous and is provided from a remote location). In particular, some AutoCITE embodiments enable one therapist to treat multiple patients at the same time. For example, the treatment of four patients at the same time using AutoCITE embodiments (plus one therapist) has been modeled. Because therapist time is the main expense of CI therapy (when CI therapy is carried out through one-on-one supervision of a patient by a therapist), use of AutoCITE embodiments wherein four patients are treated at the same time could reduce the cost of administering CI therapy by approximately two-thirds (though not by approximately three-quarters because administrative and space requirements would yet remain). The cost reductions that some AutoCITE embodiments may facilitate are particularly significant given that, in the current health care system in the United States, a frequent focus is on cost containment (and wherein the provision of services by health care payers is being cut back sharply for physical rehabilitation). Because some AutoCITE embodiments may even be operated almost entirely by a subject (i.e., almost entirely without oversight by a therapist), these embodiments may be particularly advantageous from a cost perspective (i.e., by greatly reducing the need for therapist supervision, these embodiments would also greatly reduce costs associated with providing therapist supervision). Overall, various AutoCITE embodiments (and associated systems and methods) could possibly help several hundred thousand or more chronic CVA patients (as well as patients with TBI, brain resection, Multiple Sclerosis or SCI) realize motor gains even in a health care system that has cost containment as a focus.

AutoCITE embodiments provided include a workstation for automated constraint-induced movement therapy (i.e., automated CI therapy), the workstation comprising: a cabinet comprising an extensible work surface for positioning a task input device; a computer; a control input device for receiving workstation control parameter data, for transforming the received workstation control parameter data, and for transmitting the transformed workstation control parameter data to the computer; a task input device for receiving task performance data, for transforming the received task performance data, and for transmitting the transformed task performance data to the computer; a control device for receiving from the computer further transformed workstation control parameter data (electronic instructions for control of the workstation) and for controlling the workstation using the further transformed workstation control parameter data; and a data feedback device for receiving from the computer further transformed task performance data and for displaying the further transformed task performance data in a readable format; wherein the computer further transforms the transformed workstation control parameter data received from the control input device into further transformed workstation control parameter data (electronic instructions for control of the workstation), and wherein the computer exports the further transformed workstation control data to a control device for control of the workstation by the control device, and wherein the computer further transforms the transformed task performance data received from the task input device into further transformed task performance data for display by the data feedback device in a readable format.

AutoCITE method embodiments provided also include a method of tele-rehabilitation, wherein the method comprises: remotely monitoring further transformed task performance data from a workstation being used for automated constraint-induced movement therapy (i.e., automated CI therapy), wherein the workstation comprises components as described in the previous paragraph and elsewhere herein; and remotely providing data responsive to the further transformed task performance data from the workstation.

AutoCITE computer-readable medium embodiments provided include a computer readable medium having computer-executable instructions for performing acts comprising: receiving task performance data from a task input device; transforming the received task performance data; and transmitting the transformed task performance data to a computer, wherein the computer further transforms the transformed task performance data received from the task input device into further transformed task performance data for display by a data feedback device in a readable format, and wherein the task input device is part of a workstation.

AutoCITE computer-readable medium embodiments provided also include a computer readable medium having computer-executable instructions for performing acts further comprising: remotely monitoring further transformed task performance data from a workstation being used for automated constraint-induced movement therapy (i.e., automated CI therapy), wherein the workstation comprises components as described in previous paragraphs and elsewhere herein; and remotely providing data responsive to the further transformed task performance data from the workstation.

AutoCITE telerehabilitation system embodiments provided include a telerahabilitation system for effecting automated constraint-induced movement therapy (i.e., automated CI therapy), the system comprising: a device for remotely receiving further transformed task performance data from a workstation being used for automated CI therapy, wherein the workstation comprises components as described in previous paragraphs and elsewhere herein; and a device for remotely providing data responsive to the further transformed task performance data from the workstation.

### BRIEF DESCRIPTION OF THE DRAWINGS

A more complete appreciation of the disclosed embodiments and their attendant advantages will be readily obtained and better understood by reference to the following detailed description when considered in conjunction with the accompanying drawings (it being understood that the drawings contained herein are not necessarily drawn to scale); wherein, for various AutoCITE embodiments:

FIG. 1A represents a workstation in which all four work surfaces are retracted; a back view of a patient's chair having an adjustable arm attached on the chair's left side is also displayed;

FIG. 1B represents a front view of a patient's chair having an adjustable arm attached on the chair's right side; the adjustable arm contains two buttons that are used in selecting and performing tasks;

FIG. 1C represents a touch screen monitor having a screen displaying a main menu from which tasks are selected;

FIG. 2A represents monitor on which a feedback screen summarizes a subject's performance over a set of ten trials of a task;

FIG. 2B represents monitor on which another feedback screen summarizes a subject's performance over another set of ten trials of a task;

FIGS. 3A-10B depict the use of one of eight component task devices (specifically, FIGS. 3A, 3B, 3C & 3D depict the use of task devices for Reaching; FIGS. 4A, 4B & 4C—Peg Moving; FIGS. 5A & 5B—Hand Turning; FIGS. 6A & 6B—Threading; FIGS. 7A & 7B—Tracing; FIGS. 8A & 8B—Flipping; FIGS. 9A & 9B—Finger Tapping; and FIGS. 10A & 10B—Ring-and-Arc Rotation);

FIG. 11 summarizes performance data on a Peg Moving task by a single subject;

FIGS. 12A-12F summarize performance data on a Tracing task by a single subject; and

FIG. 13 illustrates a computer system upon which an embodiment may be implemented.

### DETAILED DESCRIPTION

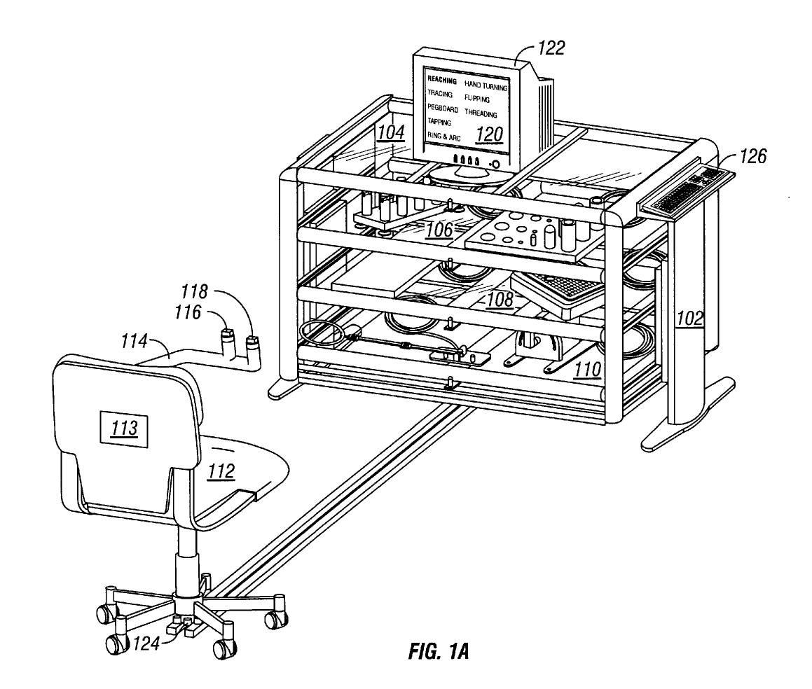

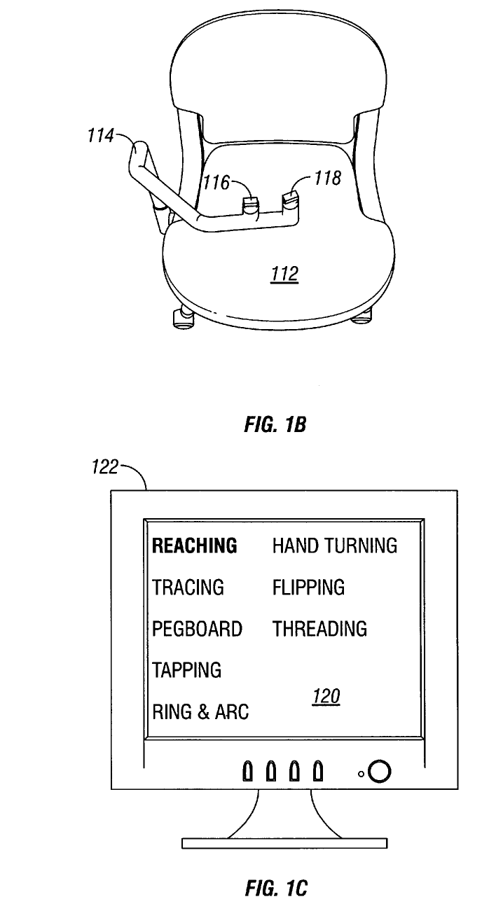

Referring to FIG. 1A, an AutoCITE workstation embodiment is depicted in which all four work surfaces are retracted; also disclosed is patient's chair (back view) having an adjustable arm attached on the chair's left side. The embodiment depicted of the AutoCITE workstation is a motorized cabinet 102 containing four extensible work surfaces, i.e., surfaces 104, 106, 108 and 110 (although in some embodiments, the cabinet may not be motorized; furthermore, in some embodiments, the cabinet, whether or not motorized, may contain one to two, three, four, five, six, seven, eight, nine or ten or more work surfaces). All four work surfaces are depicted in retracted positions, although in order to be accessible to a patient, a work surface usually needs to be extensible. The entire cabinet moves up or down until the correct work surface is at lap level. The work surface on which the desired component task device is located is then pulled out and locked in place over the subject's lap. A trainer can operate or set various parameters for the workstation through keyboard 126.

Referring to FIGS. 1A and 1B, chair 112 has an adjustable arm 114 containing buttons 116 and 118 near the end of adjustable arm 114. Adjustable arm 114 may be rotated into various positions so that buttons 116 and 118 are placed conveniently in front of a seated patient. The patient can use buttons 116 and 118 to navigate a task menu that appears on touch screen 120 of monitor 122. The assembly of adjustable arm 114 and buttons 116 and 118 may be reconfigured for attachment to the right or left side of chair 112 (i.e., to the side of chair 112 most suitable for a hemiparetic subject, e.g., to the left side of chair 112 as in FIG. 1A or to the right side of chair 112 as in FIG. 1B). The chair contains a back sensor 113 to provide feedback when the patient's body moves forward and loses contact with the chair back. Chair base 124 includes a locking mechanism that maintains chair 112 a prescribed distance from motorized cabinet 102 (and the cabinet's task devices; prescribed distances vary by task and the desired degree of task difficulty).

Referring to FIGS. 1A and 1C, monitor 122 may display a task selection menu (e.g., words REACHING, TRACING, PEGBOARD, TAPPING, RING & ARC, HAND TURNING, FLIPPING, and THREADING for the tasks of Reaching, Tracing, Peg Moving, Finger Tapping, Ring-and-Arc Rotation, Hand Turning, and Threading, respectively). Touch screen 120 of monitor 122 also serves as an interface for two tasks: Reaching and Tracing. In addition, touch screen 120 displays pertinent information during a treatment session. Furthermore, through touch screen 120, the subject may view encouraging feedback in some embodiments (e.g., as provided by a shaping or an autoshaping algorithm).

Additional descriptions of the AutoCITE workstation embodiment and related embodiments are provided in the Examples below.

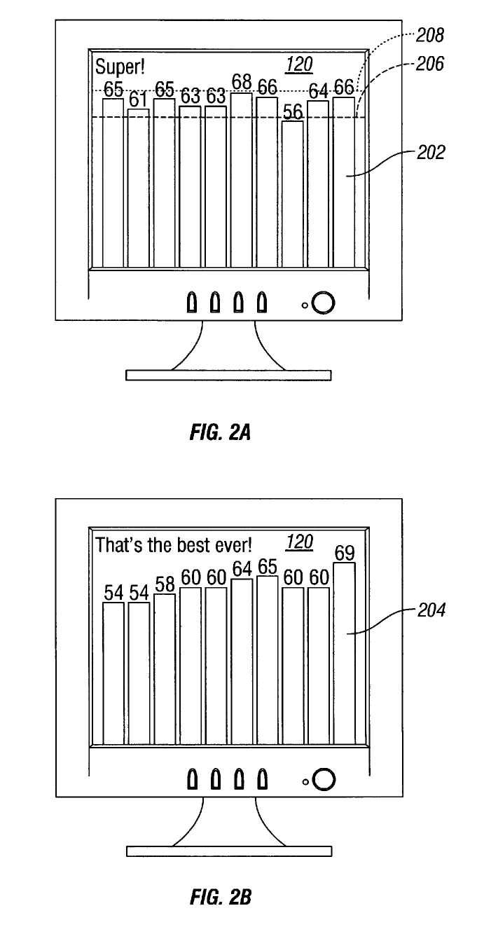

Referring to FIGS. 2A and 2B, touch screen 120 in feedback mode displays the encouraging message “Super!” in response to a subject achieving a trial score of “66” (rightmost bar 202 of ten-bar histogram in FIG. 2A), and touch screen 120 in feedback mode displays the message “That's the best ever!” in response to a subject achieving a trial score of “69” (rightmost bar 204 of ten-bar histogram in FIG. 2B). A trial score (number of repetitions) is displayed at the top of each of ten bars of the histogram (each bar being proportional in height to the number of repetitions achieved by the subject in the trial). From the first to last (left to right) bar in FIG. 2A, these trial scores are: 65, 61, 65, 63, 63, 68, 66, 56, 64 and 66, and, in FIG. 2B, these trial scores are: 54, 54, 58, 60, 60, 64, 65, 60, 60 and 69.

A feedback screen is shown after every trial. Commonly the screen displays a histogram of the patient's performance over the course of ten previous trials. As in FIGS. 2A and 2B, numerals over each bar specify a patient's exact performance value for each of these trials. In addition, a horizontal line of one color or distinguishable pattern may cross the histogram at a height corresponding to the average of the ten trials of a presently displayed histogram (or the average of a set of earlier trials, e.g., hashed line 206 in FIG. 2A at a height corresponding to about 57, which represents an average for a set of earlier trials). Another horizontal line of different color or distinguishable pattern may cross the histogram at a height corresponding to the patient's previous overall best performance in a trial (e.g., dashed line 208 in FIG. 2A at a height corresponding to about 69, which represents a best score for a subject). In some embodiments, other lines or pedagogically helpful features may be displayed. During trials for tasks that do not require use of a touch screen (e.g., Peg Moving, Finger Tapping, Ring-and-Arc Rotation, Hand Turning, and Threading tasks), the screen typically displays special instructions and parameter information.

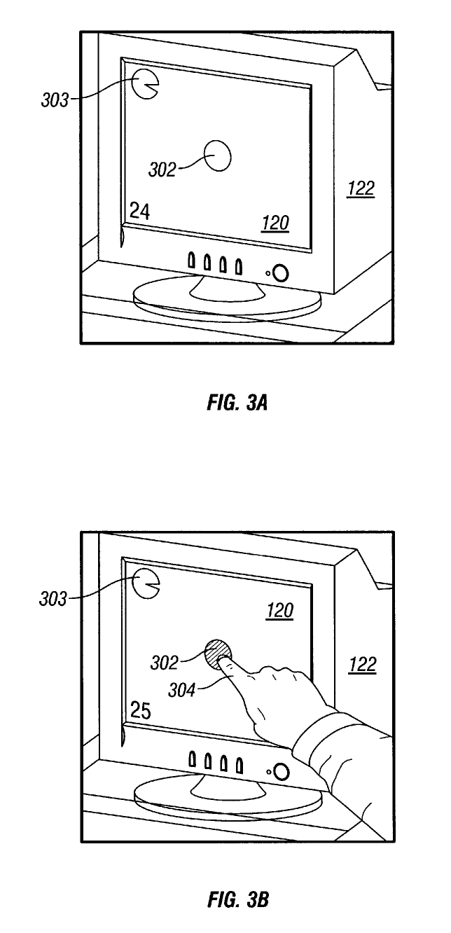

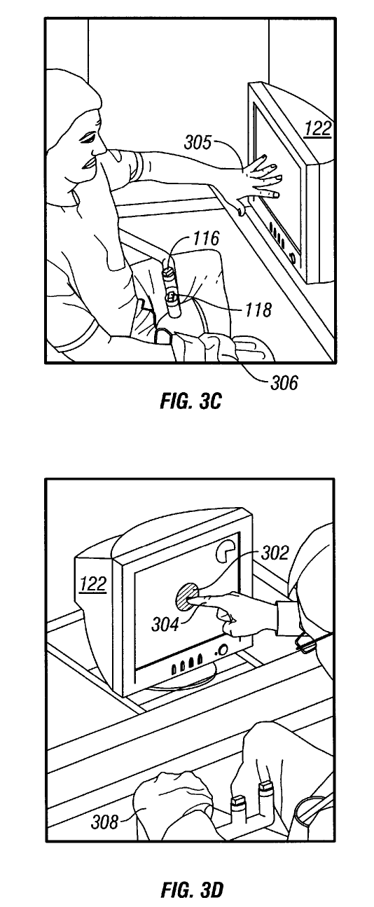

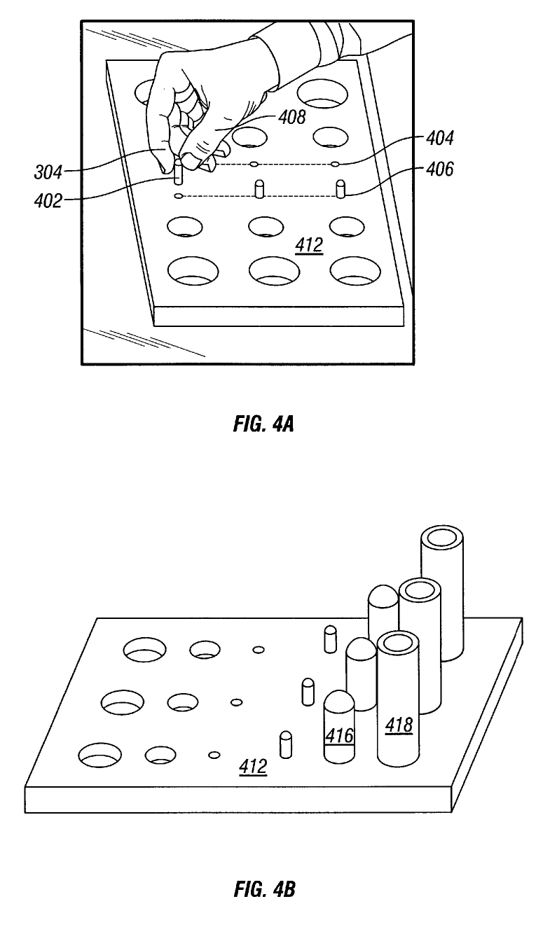

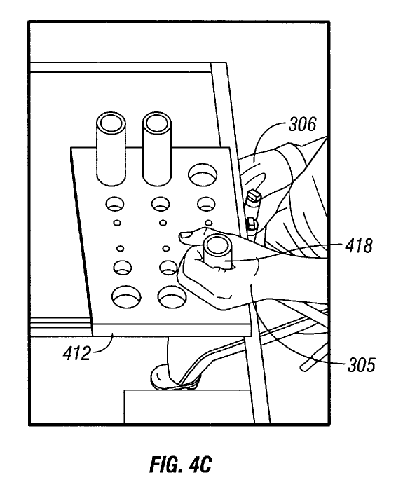

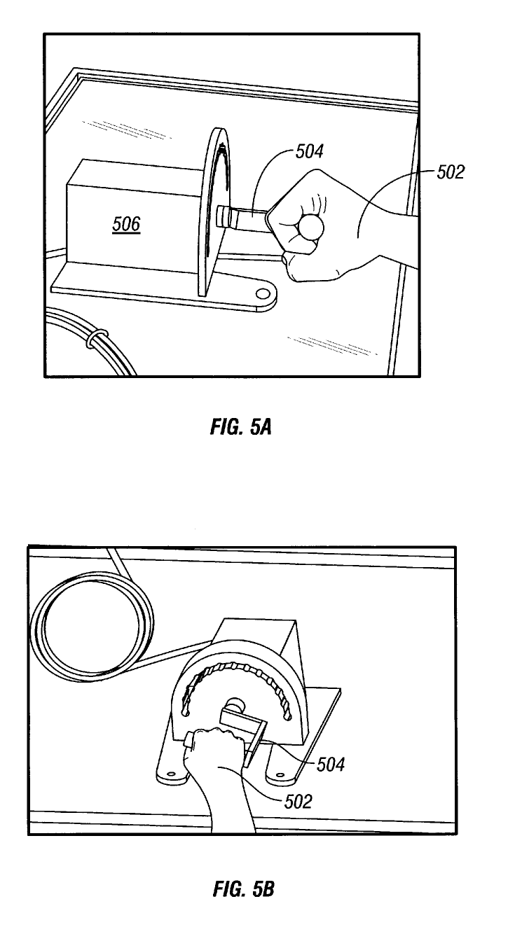

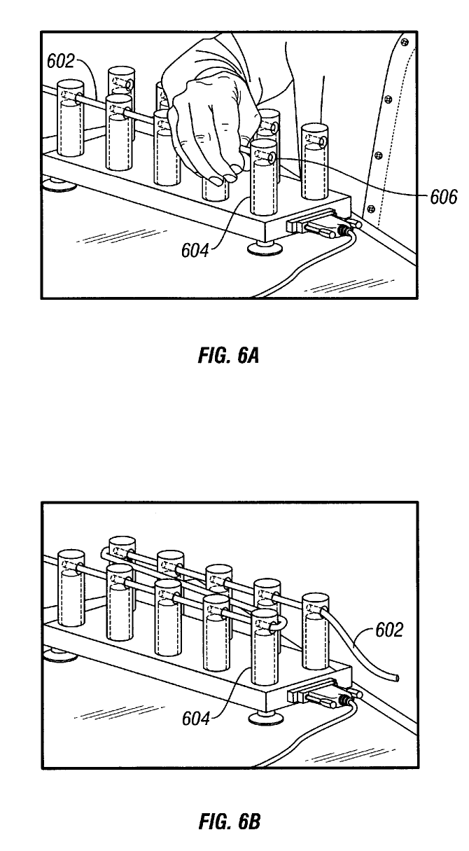

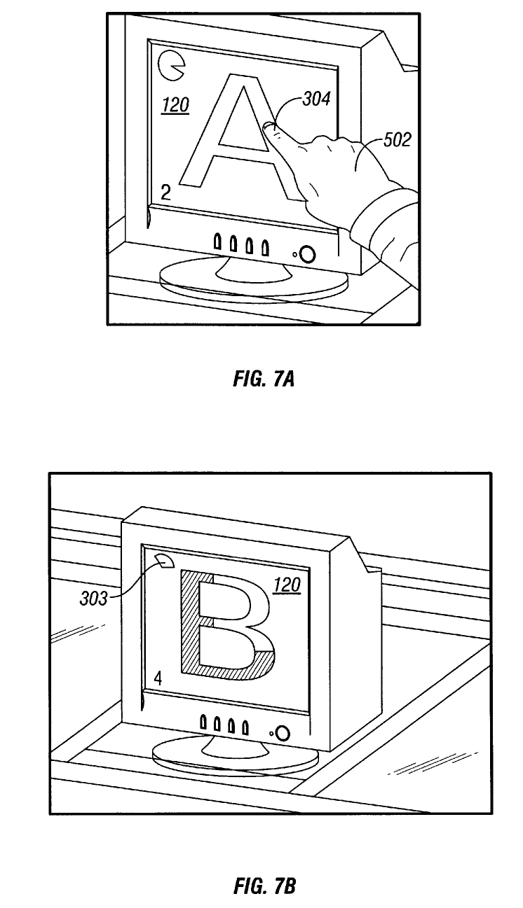

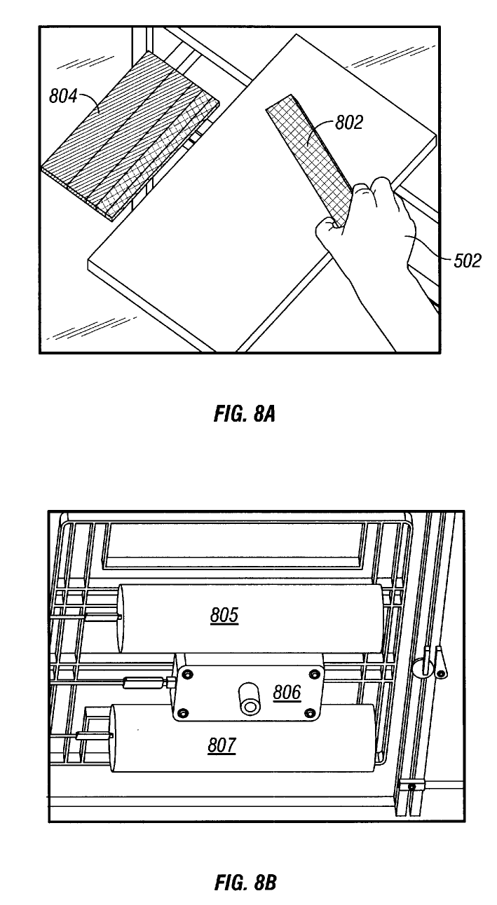

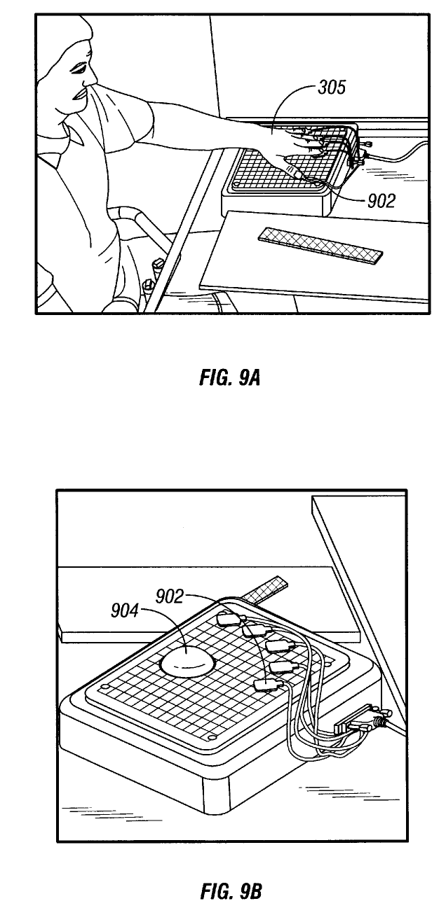

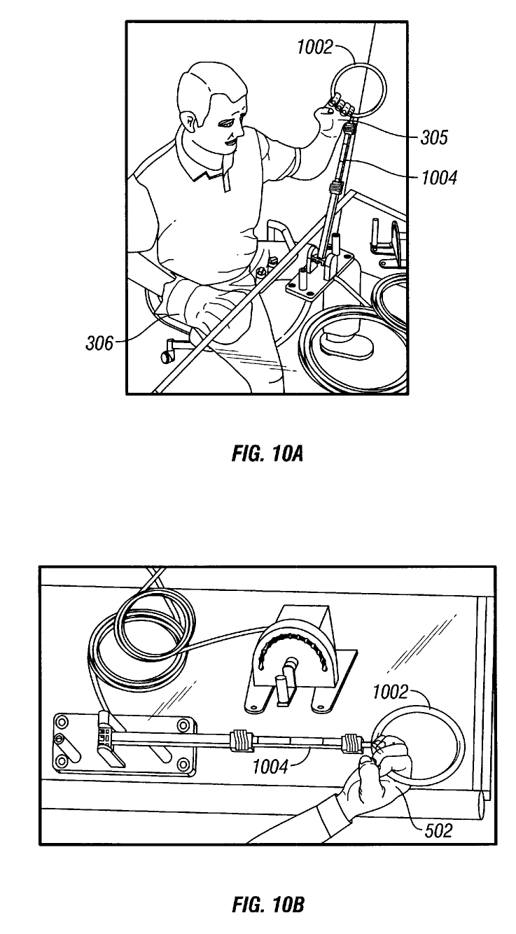

Referring to FIGS. 3A to 10B, depictions of use of one of eight component device embodiments for AutoCITE tasks are provided (specifically, FIGS. 3A to 3D depict use of task devices for Reaching; FIGS. 4A to 4C—Pegboard or Peg Moving; FIGS. 5A & 5B—Supination/Pronation or Hand Turning; FIGS. 6A & 6B—Threading; FIGS. 7A & 7B—Tracing; FIGS. 8A & 8B—Flipping; FIGS. 9A & 9B—Finger Tapping; and FIGS. 10A & 10B—Ring-and-Arc Rotation). Additional descriptions for each task are provided in the Examples below.

Referring to FIGS. 3A to 3D, after a patient initiates a Reaching task (by touching button 116 or 118 on adjustable arm 114; see FIGS. 1A & 1B, as well as FIG. 3C) of a Reaching task trial, the patient must then touch (e.g., with index finger 304 or some other part of hand) a circular target like circular target 302 on touch screen 120 of monitor 122. Circular target 302 fills (e.g., with white, which is represented by a slash pattern in FIGS. 3B & 3D) when it is touched, and one repetition of Reaching is complete. The patient then begins a new cycle by touching button 116 or 118 (on adjustable arm 114), which clears circular target 302. The difficulty of the Reaching task may be modified (e.g., for shaping purposes) by making various changes relative to the patient's position (e.g., increasing or decreasing the distance to, or height of, screen 120; increasing or decreasing the diameter of circular target 302; or, see FIG. 1A, changing the angle of chair 112). As indicated in FIG. 3C, fingers of hand 305 other than the index finger may be used to complete a Reaching task. In some embodiments, the unaffected or less affected hand is restrained (e.g., in mitt 306, as in FIG. 3C, or in mitt 308, as in FIG. 3D).

In some embodiments of the Reaching task device, touch screen 120 may display during a trial, in addition to the circular target, an indication of time remaining for the patient to complete the trial (e.g., toward the upper right or upper left corner of touch screen 120). In some embodiments for example, radially filling circle 303 toward the upper left (or right) corner of the screen informs a patient of time remaining for the patient to complete a trial (as in FIGS. 3A & 3B; see also FIG. 3D where the filling circle is in the upper right of the touch screen of monitor 122). In some embodiments, touch screen 120 may also display the number of repetitions that a patient has completed during the course of a trial (e.g., in the form of a number toward the lower right or lower left corner of touch screen 120, as in numbers “24” and “25” in the lower left of screen 120 of FIGS. 3A & 3B, respectively).

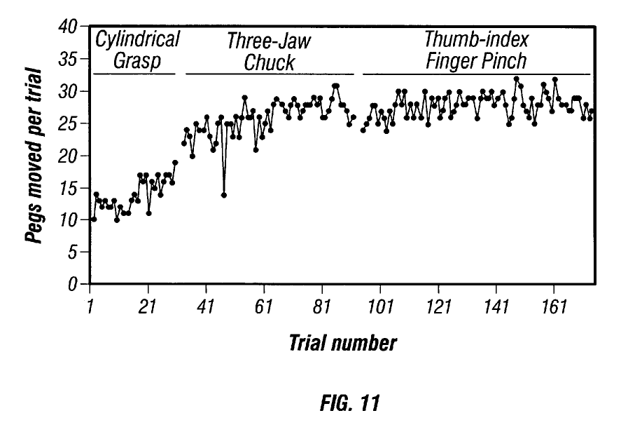

Referring to FIGS. 4A & 4B, a patient's hand, as part of the Moving Pegs task trial, is moving the last small peg 402 of three small pegs from an upper or right side row 404 to a lower or left side row 406 of pegboard 412 in FIG. 4A. Moving a small peg like peg 402 generally requires that the patient use a thumb 408 and index finger 304 pinch (with the right hand, or a similar thumb-and-index-finger pinch with the left hand). This embodiment of the Pegboard task requires that patients move three pegs from one side of a pegboard like pegboard 412 to the corresponding holes on the opposite side of the pegboard. All three pegs must be moved before the pegs can be returned to the start position. The difficulty of the Pegboard or Moving Pegs task may be modified (e.g., for shaping purposes) by changing the size of the pegs that the patient is required to move. Moving small pegs like peg 402 is more difficult for many patients than moving intermediate-size pegs (like peg 416 of FIG. 4B) that require a three-jaw chuck grasp. In turn, moving intermediate-size pegs may be more difficult than moving large pegs (like peg 418 of FIG. 4B) that require a cylindrical grip or grasp (see also FIG. 11 and the discussion for FIG. 11 below). The nature of a specific patient's impairment may make moving pegs of one size more difficult than moving pegs of other sizes, and levels of difficulty for shaping purposes may be modified accordingly.

Referring to FIG. 4C, a patient is using a cylindrical grip in left hand 305 to move large peg 418 from an upper or right side row to a lower or left side row of pegboard 412. Mitt 306 restrains the unaffected or less affected right hand of the patient from participating in the trial.

Referring to FIGS. 5A & 5B, a patient's right hand 502, as part of the Hand Turning task trial, is rotating a handle 504 through a given arc by alternately pronating and supinating his or her forearm (not shown). In this embodiment, handle 504 is mounted to shaft and bearing assembly 506 that allows rotation about an axis through the forearm. A digital shaft encoder measures the position of the handle, and an electromagnetic brake on the shaft coupled to the encoder stimulates mechanical stops at endpoints of an arc by engaging when a particular angle is exceeded in each direction. A patient rotates the handle back and forth between these two stops by alternately pronating and supinating his or her forearm. The difficulty of the Hand Turning task may be modified (e.g., for shaping purposes) by changing the length of the arc. The stops on either side of can also be of a mechanical nature (e.g., wherein a bar is put through a hole in the rotating disk and thereby limits its motion).

Referring to FIGS. 6A & 6B, a patient, as part of a Threading task trial, is guiding shoestring 602 through a series of holes drilled into mounted pegs or posts like post 604. In this embodiment, shoestring 602 contains a magnet that activates a sensor located in each post as the shoestring passes through the post. Circular openings on sides of the posts (like wide circular opening 606 with chamfered edges) may differ in diameter in some embodiments (i.e., the diameter of the opening on one side of a post may be greater than the diameter of the opening on the other side, like the narrow circular opening that is opposite wide circular opening 606 with chamfered edges). The difficulty of the Threading task may be modified (e.g., for shaping purposes) by having the patient thread shoestring 604 through the consistently larger-diameter (or smaller-diameter) openings in the sides of posts. Needless to say, initially threading shoestring 604 through smaller-diameter openings would represent a more difficult task than initially threading shoestring 604 through larger-diameter openings on posts. In some embodiments, two or more holes of different sizes may be placed on the posts in order to allow a choice for modifying the difficulty of the task (e.g., for shaping purposes). One embodiment of a Threading device after completion of a task trial is shown in FIG. 6B.

Referring to FIG. 7A, a patient, as part of a Tracing task trial, is using his or her index finger 304 to trace the letter A on touch screen 120. In some embodiments of the Tracing task device, a patient is required to trace letters A through G on the touch screen using part of his or her hand 502. As index finger 304 (or other portion of the hand) passes over an area of the outlined letter, the AutoCITE computer system responds by filling in that portion of the letter's image (e.g., by lighting the corresponding pixels on touch screen 120).

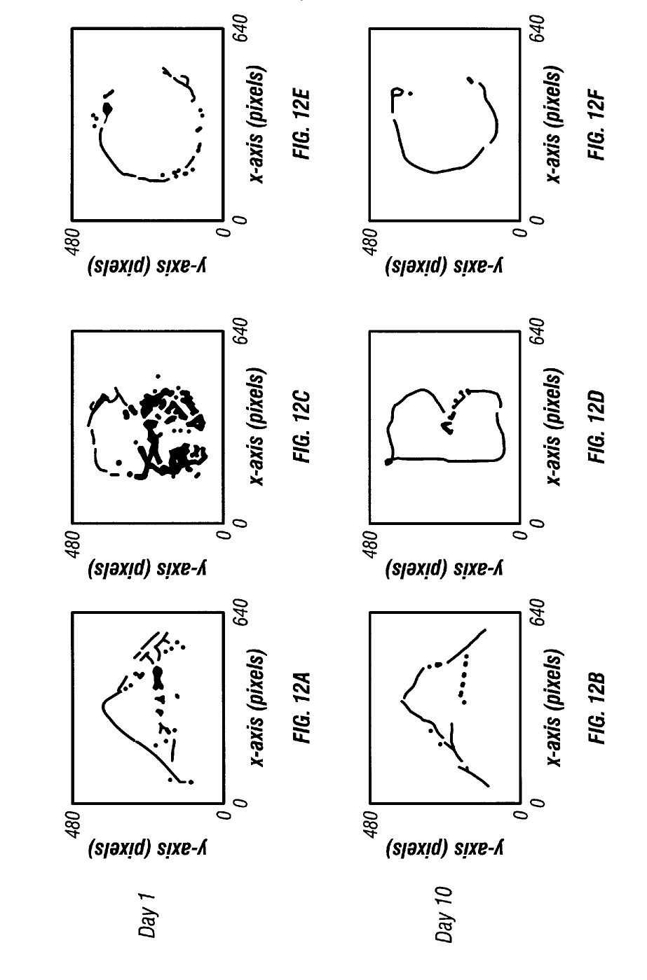

Referring to FIG. 7B, the patient has traced over all of the left and lower side the letter B on touch screen 120 (as indicated by the slash pattern in the depicted letter B). The difficulty of the Tracing task may be modified (e.g., for shaping purposes) by increasing or decreasing the distance to, or height of, touch screen 120, or by changing the width of the letters that are to be traced (see also FIGS. 12A to 12F and the associated discussion of FIGS. 12A to 12F below). In the embodiment of FIG. 7B, radially filling circle 303 (i.e., in the form of a piece of a pie) indicates that the patient has yet used only about a third of the time allotted to complete the trial, and the numeral “4” in the lower left of screen 120 indicates that the patient has previously completed four tracings.

Referring to FIGS. 8A & 8B, a patient, as part of a Flipping task trial, is grasping a wooden block 802 in his or her hand 502 (e.g., using at least the thumb and forefinger) in order to flip the wooden block from one side (e.g., a blue side, as indicated by a hatched pattern on wooden block 802 in FIG. 8A) to the other side (e.g., a red side, as indicated by a slash pattern on wooden block 804 in FIG. 8A). In this embodiment, camera 806 and lights 805 and 807 of FIG. 8B are mounted below work surface 104 and above work surface 108 (see FIG. 1A). One or more cameras like camera 806 are used to record the ratio of red to blue in the field of view in various embodiments. When the patient flips the object (such as wooden block 802) from the red side to the blue side (or visa versa), one or more cameras like camera 806 sense this change and record a repetition (one or more other cameras may be mounted below a transparent work surface in some embodiments). The difficulty of the Flipping task may be modified (e.g., for shaping purposes) by increasing or decreasing the size of the block or other object that is flipped. For many patients, flipping smaller blocks is more difficult than flipping larger blocks.

Referring to FIGS. 9A & 9B, a patient, as part of a Tapping or Finger Tapping task trial, utilizes five finger sensors (like thumb sensor 902 of FIGS. 9A & 9B) in this embodiment to record how many times the patient can tap each digit on an individual basis. The sensors also record the length of time digits other than an indicated finger spend raised (i.e., off its corresponding sensor). Palm rest 904 (as shown in FIG. 9B) can be raised or lowered in order to accommodate patients with greater levels of hypertonicity. The difficulty of the Finger Tapping task may be modified (e.g., for shaping purposes) by raising or lowering palm rest 904. For example, if a patient has a hypertonic/cupped hand, palm rest 904 can be lowered to make the Finger Tapping task more difficult; a lowered palm rest requires the patient to keep the palm of the hand flatter, which would present a more difficult task for a patient who has a hypertonic/cupped hand.

Referring to FIGS. 10A & 10B, a patient, as part of a Ring-and-Arc Rotation task trial, grasps ring 1002 with his or her affected (or more affected) hand (e.g., left hand 305 of FIG. 10A, or right hand 502 of FIG. 10B) and moves it through an arc of a given radius (as determined by the length of telescoping arm 1004), e.g., from a horizontal position through a vertical position (as depicted in FIG. 10A) to an opposite horizontal position in this embodiment. A sensor records the movement of ring 1002 and scores repetitions after the patient has moved ring 1002 a proper distance (e.g., through the entire arc). The difficulty of the Ring-and-Arc Rotation task may be modified (e.g., for shaping purposes) by extending or retracting telescoping arm 1004. For example, extending telescoping arm 1004 requires the patient to move ring 1002 through a larger arc, which is typically a more difficult task for a patient than moving ring 1002 through a smaller arc. In some embodiments, the unaffected or less affected hand is restrained (e.g., in mitt 306, as in FIG. 10A).

Referring to FIG. 11, data over a two-week training period from a single subject's performance in the Moving Pegs task is summarized. Gains in terms of number of repetitions were apparent in the first week of training even though the task moved from a requirement for a cylindrical grasp (large pegs) to a three-jaw-chuck grasp (intermediate size pegs). Difficulty was increased further by moving to a requirement for a thumb-index finger pinch (small pegs), but performance nevertheless stabilized at approximately double the number of pegs moved at the start of training. The single subject moved a total of at least 4,190 pegs over the two-week period.

Referring to FIGS. 12A to 12F, comparisons on Day 1 versus Day 10 of representative performances by a single subject on Tracing task trials are shown (more specifically, representative performances on tracing the A-B-C letter sequence are shown). The evident improvement in the subject's performance is particularly impressive in that the task was much more difficult on Day 10 compared to Day 1: the monitor was 20.3 cm further away and 5.1 cm higher on Day 10 than on Day 1. Gaps in the tracings indicate times when the subject's finger was lifted off the touch screen surface of the monitor.

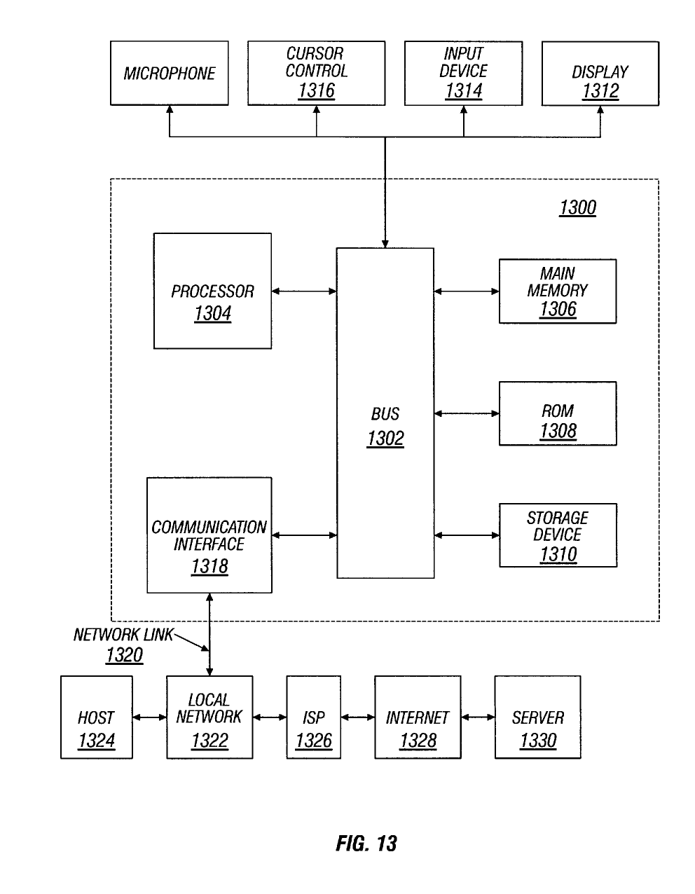

Referring to FIG. 13, a block diagram illustrates an exemplary computer system 1300 upon which process flows in accordance with principles of embodiments may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user (e.g., for displaying information to a patient at an AutoCITE workstation 102 on screen 120 of FIG. 1A). An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312 (e.g., buttons 116 and 118 on adjustable arm 114 of FIGS. 1A, 1B and 3C may function as keys for selecting or initiating tasks; other cursor controls may occur on keyboard 126 of FIG. 1 A). This input device typically has two degrees of freedom in two axes, a first axis (e.g., x) and a second axis (e.g., y), that allows the device to specify positions in a plane.

One or more populating acts may be provided by computer system 1300 in response to processor 1304 executing one or more sequences of one or more instructions contained in main memory 1306. Such instructions may be read into main memory 1306 from another computer-readable medium, such as storage device 1310. Execution of the sequences of instructions contained in main memory 1306 causes processor 1304 to perform processes described herein. One or more processors in a multi-processing arrangement may also be employed to execute the sequences of instructions contained in main memory 1306. In other embodiments, hard-wired circuitry may be used in place of, or in combination with, software instructions. Thus, embodiments are not limited to any specific combination of hardware circuitry and software.

The term “computer-readable medium” as used herein refers to any medium that participates in providing instructions to processor 1304 for execution. Such a medium may take many forms, including but not limited to, non-volatile media, volatile media, and transmission media. Non-volatile media include, for example, optical or magnetic disks, such as storage device 1310. Volatile media include dynamic memory, such as main memory 1306. Transmission media include coaxial cables, copper wire and fiber optics, including the wires that comprise bus 1302. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1304 for execution. For example, the instructions may initially be borne on a magnetic disk of a remote computer. The remote computer can load the instructions into its dynamic memory and send the instructions over a telephone line using a modem. A modem local to computer system 1300 can receive the data on the telephone line and use an infrared transmitter to convert the data to an infrared signal. An infrared detector coupled to bus 1302 can receive the data carried in the infrared signal and place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the worldwide packet data communication network, now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are exemplary forms of carrier waves transporting the information.

Computer system 1300 can send messages and receive data, including program code, through the network(s), network link 1320, and communication interface 1318. In the Internet example, a server 1330 might transmit a requested code for an application program through Internet 1328, ISP 1326, local network 1322 and communication interface 1318. One such downloaded application may provide for, or participate in, operating an AutoCITE workstation as described herein for various embodiments. The received code may be executed by processor 1304 as it is received, and/or stored in storage device 1310, or other non-volatile storage for later execution. In this manner, computer system 1300 may obtain application code in the form of a carrier wave.

### EXAMPLE 1

Summary. This example reports progress in the development of an AutoCITE embodiment, i.e., one that delivers task practice components of upper-limb CI therapy and that can be used in the clinic or the home without the need for one-on-one supervision from a therapist. In this AutoCITE embodiment, a computer and eight component task devices are arranged on a modified cabinet. Task performance is automatically recorded, and several types of feedback are provided. In preliminary testing, nine chronic stroke subjects with mild to moderate motor deficits practiced with this AutoCITE workstation for three hours each weekday for two weeks. Subjects wore a padded mitt on the less affected hand for a target of 90% of their waking hours. In terms of effect sizes, gains were large and significant on the Motor Activity Log (MAL), and moderate to large on the Wolf Motor Function Test (WMFT). These gains were comparable to the gains of a matched group of twelve subjects who received standard CI therapy. (Much material of this example and the next example is from Lum et al., 2004, “Automated constraint-induced therapy extension (AutoCITE) for movement deficits after stroke,” J Rehabil Res Dev. 41: 249-258, which is one of three papers that constitutes U.S. patent application Ser. No. 60/692,331 entitled “Automated constraint-induced therapy extension (autocite)” by Edward Taub and Peter S. Lum, filed Jun. 20, 2005, which is again hereby incorporated by reference in its entirety.)

Introduction. The primary goal of this preliminary testing was to determine if interposing an AutoCITE workstation between the subject and the therapist compromises the effectiveness of the training procedure. Three factors were viewed a potentially diminishing the effectiveness of AutoCITE-based therapy relative to standard one-on-one shaping with a therapist. First, in standard CI therapy, the therapist can choose from a bank of well over 100 tasks, and can customize the tasks employed for each subject by creating new tasks that might be particularly useful or motivating. In contrast, the tested AutoCITE workstation has only eight component task devices (although in other embodiments, the number of component task devices in an AutoCITE workstation may range from as few as two to more than 100). Second, therapists have considerably more flexibility in shaping a task versus the number of shaping options that may be implemented with the tested AutoCITE workstation. Third, patients typically must interact with a computer in these tests, which could be less motivating than receiving continuous one-on-one attention from a therapist.

A therapist was present or readily available during all the training sessions in this preliminary study in order to ensure the smooth functioning of this new procedure. However, the sessions were arranged so that the therapist supervised the interactions between the subject and the tested AutoCITE workstation instead of administering the training directly. For example, instructions and encouragement for the subject were issued predominantly by the computer, with the therapist interjecting comments occasionally to supply additional encouragement, or if the subject became confused or could not understand the instructions.

The specific question addressed in this Example's study was whether a group of stroke subjects given CI therapy by means of the tested AutoCITE workstation would achieve as large a treatment effect as a group of subjects who received CI therapy in a nonautomated setting. Both groups were equivalent in all significant demographic characteristics and had similar initial upper-limb motor deficit.

Apparatus and General Methods. In this AutoCITE embodiment, a computer provides simple one-step instructions on a monitor 122 (FIG. 1A) that guides the subject through the entire treatment session. Sensors built into the workstation 102 verify completion of each instruction before the next instruction is given. Because hand function in all subjects is initially compromised (and the less impaired hand of each subject is in a mitt), the workstation 102 is designed to be operated with gross movements at each of the joints. A rotating arm 114 is attached to the subject's chair 112 and is swung in front of the subject during the session. The rotating arm has two pushbuttons (e.g., at 114 and 116 of FIGS. 1A, 1B and 3C) that are used by the subject when a choice is to be made and to allow the subject to control the flow of the session by informing the computer that he or she is ready to move to the next step. Data are collected by a computer that is equipped with a digital input/output PC card (PC-DIO-96, National Instruments, Austin, Tex.), and an encoder reader PC card (PC7166, US Digital Corp., Vancouver, Wash.). All software was custom-written in the C programming language.

Eight tasks are automated in this AutoCITE embodiment. Each task device was custom-manufactured and uses simple and inexpensive means to record performance during the exercise. The activities are based on tasks used in CI therapy administered one-on-one by a therapist and collectively address shoulder, elbow, hand, and wrist function. The eight task devices are arrayed in a cabinet on four tiered work surfaces 104, 106, 108 and 110, and the height of each work surface is automatically adjusted when a specific task is selected. When a work surface has been raised or lowered to an appropriate height, the work surface can be manually pulled out like a drawer and locked over the subject's lap. Two tasks are located on each work surface. The top work surface, on which monitor 122 is placed, can be pulled out and locked in three positions, allowing adjustment of the distance from the subject to the device. Switches detect the position of each work surface.

In this AutoCITE embodiment, a subject sits in customized chair 112 that can be moved to different distances from the table (e.g., depending on the arm length of the subject) and locked into place through locking mechanisms in chair base 124. Chair 112 can also rotate and be locked at several angles. A digital shaft encoder (E2 Optical Kit Encoder, US Digital Corp.) measures the angle of chair 112, and a limit switch detects the flex of the chair as the subject leans back against the seat. Data from the latter sensor are used by the computer program to sound a buzzer when a subject is leaning too far forward during task practice. A computer monitor with a touch screen (Entuitive 1725C, Elo TouchSystems, Fremont, Calif.) is located on the top shelf and has multiple functions: display of the menu for task selection; provision of various types of performance feedback; display of instructions for the subject to set up and perform each task; and display and interface for two tasks that involve the touch screen directly (i.e., Reaching and Tracing). The constraints of the apparatus require that each task be performed correctly, within limits, and deviations from prescribed performance are recorded.

At the beginning of each session in which this AutoCITE embodiment is used, all work surfaces are in a storage position (i.e., retracted). The subject uses buttons 116 and 118 on rotating or adjustable arm 114 to select a task from the menu displayed on computer monitor 122. The computer program controls a motorized linear actuator (Desklift DL1, Linak Inc., Louisville, Ky.) that automatically moves the workstation up or down, stopping when the appropriate work surface is positioned at lap level. The subject then pulls the work surface out, locks it in place, and begins the task. The computer program guides the subject through a set of ten 30 second trials with the selected task. The subject is instructed to repeat a task as many times as possible within each 30 second trial interval. Final feedback for that task is presented and the task menu is then displayed on screen 120, making it possible for the subject to select the next task.

This AutoCITE embodiment provides several types of performance feedback. The time remaining on each trial is shown to the subject on the computer monitor by a circular display whose filled area progressively increases along a moving radius line as time elapses (e.g., at 303 of FIGS. 3A &3B). The computer produces an audible beep when a repetition is completed. The number of repetitions of the required task movement is displayed to the subject after each trial in the form of a new bar (e.g., as in bar 202 of FIG. 2A or bar 204 of FIG. 2B) on a graph (i.e., a histogram) containing a bar for each trial in that set. The height of the bars is proportional to the number of repetitions of the task in each trial; in addition, the number of repetitions is displayed as an Arabic numeral above each bar. In some embodiments, a horizontal line of one color (e.g., red) or distinguishable pattern across the bar graph indicates the best previous single trial performance for that task, while a horizontal line of another color (e.g., blue) or distinguishable pattern indicates the mean performance of the previous set of ten trials (e.g., see hashed line 206 and dashed line 208 of FIG. 2A). One observation was that subjects tended to pay more attention and receive more performance motivation from the end-of-trial display than from the within-trial elapsed time indicator.

Other types of performance feedback are provided in some embodiments. These include encouraging comments, such as “Wow,” “That's a new record,” or “Keep up the good work.” The computer provides comments like these when a new best performance is attained for all trials of that task. Other sets of comments are used to encourage subjects if performance is well below average (e.g., “Let's keep trying,” “Ready for another try”) or if performance is not a new best, but is better than the average on the previous set (e.g., “Well done,” “Good work”). Data are collected at 250 Hz and stored for later examination.

Though a goal was to have the subjects operate the workstation without physical assistance from the therapist, one aspect of the workstation, related to changing from one task to another, could not be easily performed by some subjects with their more-affected limb in this prototype device; locking, unlocking, and pulling out the work surfaces required more arm function than most of the subjects possessed and was therefore carried out by the therapist. Also, it was found that the increments in the positions of the top work surface were too large in one embodiment to be used as a shaping parameter for Reaching and Tracing tasks. Therefore, in order to increase the distance of the monitor from the subject, the therapist positioned it manually in inch increments in this one embodiment. The weight of the monitor prevented any movement of the work surface resulting from contact with the touch screen during task performance. However, all subjects carried out all other aspects of task setup without assistance from the therapist.

During testing with the device, the therapist supervised the session by operating keyboard 126 of the computer and providing verbal encouragement to the subject when needed. The therapist could bring up a special display screen that presented the subject's performance from all trials of a particular task since the beginning of the two-week treatment. The therapist also used keyboard 126 to modify the difficulty of each task using the principles of CI therapy shaping. Snapshots of embodiments of each task device are provided in FIGS. 3A to 10B, and brief descriptions of embodiments of implementing each task follow.

Reaching. This task involves successive tapping of a button (e.g., button 116 or 118) positioned on rotating or adjustable arm 114 just in front of the body and a target circle 302 located on the touch screen monitor 122. When the touch screen is touched (e.g., by the patient's index finger 304), a conductive coating on a transparent cover sheet makes electrical contact with a conductive coating on the glass of the monitor. This produces voltages that are analog representations of the position touched. This position information is transmitted by the touch screen controller to the computer via a serial port connection. Feedback consists of an audible beep when the target is touched and by filling in target circle 302 on the monitor. Performance is measured in units of number of cycles completed, and task difficulty can be increased by moving monitor 122 further away or higher, decreasing the size of target 302, or rotating chair 112 of the subject so that the target is located more laterally.

Moving Pegs. The task is to move three pegs from a row of holes (e.g., like rows 404 and 406) of pegboard 412 to a mirror-image row of same-sized holes on the other side of the board and then back again, etc. Each peg (like peg 402) has a magnet embedded in its base. Reed switches in the holes measure when a peg is in place. These reed switches are normally open, and they close when a magnetic field is in close proximity. Three sizes of pegs are used with a row of corresponding sized holes on either side of the board. The tallest and largest diameter pegs (11.6×3.7 cm) (like peg 418) require cylindrical grasp for prehension, the intermediate size pegs (7.2×2.0 cm) (like peg 416) require three-jaw-chuck grasp, and the smallest cylinders (3.4×0.6 cm) (like peg 402) require thumb-index finger pinch (see FIGS. 4A and 4B). Performance is measured in units of the number of pegs moved in 30 seconds.

Supination/Pronation (or Hand Turning). Subjects grasp a cylindrical handle that is mounted to shaft and bearing assembly 506 that allows rotation about an axis through the forearm. A digital shaft encoder measures the position of handle 504, and an electromagnetic brake on the shaft coupled to the encoder simulates mechanical stops by engaging when a particular angle is exceeded in each direction. Subjects rotate the handle back and forth between these two stops (see FIGS. 5A & 5B). Performance is measured in units of the number of cycles completed in 30 seconds. Difficulty is increased by engaging the brake at greater angles so that larger excursions of supination and pronation are required to complete the task.

Threading. The task is to thread a shoelace (like shoelace 602) through holes near the tops of a series of posts (7.5×2.5 cm) (like post 604) arranged in two parallel rows (see FIGS. 6A & 6B). This requires pushing the tip of the shoelace through a hole, reaching around to the other side of the post, regrasping the tip and pushing it through the next hole, and so on. Reed switches in each post measure when a magnet near the tip of the shoelace has been moved through each hole. The holes are 0.7 cm in diameter, but they differ on the two sides of the post. On one side of the post, the entry (e.g., like opening 606 of FIG. 6A) to the hole is chamfered (e.g., outer diameter 1.4 cm) so that the threading of the shoelace is facilitated, while on the other side the rim of the hole is unaltered. Performance is measured in units of the number of holes threaded in 30 seconds.

Tracing. A touch screen (like touch screen 120 of FIGS. 7A & 7B) presents large block letters that the subject has to trace with his or her fingertip or other portion of the hand. Feedback is provided by a filling in of segments surrounding the touched portions of the letter as the tracing proceeds. Difficulty is increased by decreasing the width of the letters, increasing the distance of the monitor from the subject, or increasing the height of the monitor. Performance is measured in units of the number of letters completely traced in 30 seconds.

Object-Flipping. The goal was to repeatedly flip over a rectangular block (like block 802 of FIG. 8A) selected from a set of blocks whose dimensions range from 22.5×1.2×1.3 cm to 23.0×5.0×2.8 cm. The object has to be kept on a rectangular work surface (41×23 cm). One side of the block is painted one color (e.g., blue) and the opposite side is painted another color (e.g., red). A video camera (V-XA095, Marshall Electronics, El Segundo, Calif.), video-to-VGA Converter (Cheese Video Box, Omega Multimedia, Orlando, Fla.), and custom color-discrimination circuitry detects the ratio of colors (e.g., blue to red) in the visual field to determine when the object has been flipped. Performance is measured in units of the number of flips in 30 seconds. To increase difficulty, progressively smaller blocks are typically used, although some subjects have difficulty extending their fingers so that flipping larger objects is more challenging.

Finger Tapping. Five stainless-steel pads are fastened to rare-earth magnets that are arranged on a metallic surface so that each fingertip contacts one pad when the hand is placed flat on the surface (see FIG. 9A). A metal-oxide semiconductor field-effect transistor (ZVNL110A, Zetex Semiconductors, Oldham, UK) connected to each pad detects when each finger is in contact with its corresponding pad. The task is to tap one finger as fast as possible. Performance is measured in units of the number of taps in 30 seconds. A height-adjustable doorknob (or palm rest like palm rest 904 of FIG. 9B) is located beneath the palm of the hand; subjects have to keep the palm of their hand in contact with this doorknob during the tapping. For subjects with spasticity, the doorknob can be moved upward relative to the fingertip pads, so that the task can be completed with the fingers in a more flexed position. Any of the fingers can be tested, but because of time constraints, only one finger is tested in each session.

Ring-and-Arc Rotation. This task device mimics the arc-and-rings device used in conventional physical rehabilitation. Ring 1002 is attached to the end of extensible arm 1004 that is mounted to a bearing assembly that allows rotation of the arm in the frontal plane between two fixed mechanical stops located on either side of the subject close to the horizontal (see FIGS. 10A & 10B). A digital shaft encoder measures the position of the arm of the device. The task is to grasp ring 1002 and rotate arm 1004 of the device from one mechanical stop to another. Difficulty is graded by an increase in the length of arm 1004 of the device. Performance is measured in units of the number of cycles completed in 30 seconds.

Clinical Testing. In order to evaluate whether automated CI therapy produced outcomes that were similar to those produced by therapist-administered CI therapy, data from the subjects who received treatment using an AutoCITE embodiment were compared to data from twelve subjects who received an equivalent amount of standard CI therapy. The nine individuals (seven males, two females) in the AutoCITE group were a mean of 50.9 years old (range=26.1 to 66.2 years) and had sustained a CVA more than one year earlier (mean chronicity=5.1 years; range=1.7 to 14 years). The more-affected side was the right side for six participants and the left side for the other three. All participants were right-hand dominant prior to stroke. The twelve participants (seven males, five females) in the standard CI therapy group were a mean of 51.5 years old (range=25.4 to 75.5 years) and had experienced a stroke more than one year earlier (mean chronicity=3.4 years; range=1.2 to 15.7 years). The more-affected side was the right side for six participants and the left side for the other six. Of the twelve participants, ten were right-hand dominant prior to stroke. The dominant side of the body was more impaired for six participants. All could extend at least twenty degrees at the wrist and ten degrees at each of the metacarpophalangeal and interphalangeal joints, while at the same time having greatly reduced use of the limb in ADLs.

Subjects were excluded if they had balance problems, excessive pain in any joint of the limb, uncontrolled medical problems, excessive spasticity, or cognitive problems, as indicated by a score on the Mini-Mental State Exam of less than 24. The protocol was approved by the Institutional Review Boards of the Birmingham and Palo Alto Va. Medical Centers, where the work was carried out. Each patient received a detailed description of the protocol and signed an informed consent form. The standard CI therapy subjects were recruited from the same subject pool as the AutoCITE subjects, with the same intake criteria; there were no significant differences between the two subject groups in age, time since stroke, gender, race, side of paresis, or dominance.

All subjects were asked to wear a padded safety mitt on their less-affected limb for a target of 90 percent of their waking hours over a two-week period. Each weekday during this period, subjects in the AutoCITE group received shaping using the AutoCITE embodiment for three hours, with another half hour or so for testing and record-keeping activities. A therapist experienced with CI therapy supervised the sessions. Rest intervals were given at the discretion of the therapist. The AutoCITE subjects received a mean of 3.9 tasks per hour (i.e., thirty-nine 30-second trials each hour). The standard CI therapy subjects received shaping for the same duration of time.

For all subjects, testing was carried out just before and immediately after the 14-day intervention period. The tests included the Wolf Motor Function Test (WMFT) and the Motor Activity Log (MAL). The WMFT measures performance time on fifteen tasks and the strength of forearm flexion and grip in two tasks. Subjects are requested to carry out the tasks in a laboratory setting. The MAL is a structured interview that provides a measure of spontaneous use of the more-affected upper limb in the life situation. It obtains information about common and important ADLs from such areas as feeding, dressing, and grooming, providing scores on a “How Much” scale and a “How Well” scale. The version employed here had fourteen items. Details about the treatment and testing procedures can also be found elsewhere.

Data Analysis. Repeated measures analyses of variance (ANOVAs) were used to analyze the data. The effect of treatment was evaluated as a within-subjects factor (Treatment; levels=pretreatment, posttreatment); the effect of treatment modality was evaluated as a between-subjects factor (Modality; levels=AutoCITE, standard CI therapy). The principal experimental question, whether there were differences in outcomes between the AutoCITE and standard CI therapy groups, was evaluated by testing the interaction effect (Treatment×Modality) and calculating 95-percent confidence intervals (lower limit to upper limit). Two-tailed tests with an alpha of 0.05 were used. Effect sizes were indexed using Cohen's d′ (small d′=0.14, medium d′=0.36, large d′=0.57). Standard deviations (SDs) are reported in parentheses. Data from an AutoCITE participant that displayed Parkinsonian symptoms were excluded from the analyses; WMFT data from a standard CI therapy subject whose post-treatment score was an outlier (>3 SD above the mean) were also excluded.

Results. All subjects completed the treatment and evaluations. Examination of the data showed that subjects had rapid gains within the training tasks. FIG. 11 summarizes data from a single subject in the peg board task over the two-week training period. Gains in terms of number of repetitions were apparent in the first week of training, even though the task moved from the requirement for a cylindrical grasp to a three-jaw-chuck grasp. Difficulty was increased by moving to a thumb-index finger pinch, but performance nevertheless stabilized at approximately double the number of pegs moved at the start of training. A total of at least 4,190 pegs were moved over the two-week period.

FIGS. 12A to 12F compare best performance results on the tracing task on Day 1 (FIGS. 12A, 12C & 12E) and Day 10 (FIGS. 12B, 12D & 12F) for a single subject. By test Day 10, both quality of movement and speed were substantially improved. Tracing the A-B-C letter sequence was performed in 20 seconds on Day 1 and 10.8 seconds on Day 10. This was all the more impressive considering that the task was much more difficult to accomplish on Day 10 compared to Day 1: the monitor was 20.3 cm further away and 5.1 cm higher. These results for FIG. 11 and FIGS. 12A to 12F are representative of the typical patterns of improvement seen in the other tasks and the other subjects.

Participants from both AutoCITE and standard CI therapy groups showed very large improvements in real-world arm function as measured by the MAL, and moderate to large improvements in arm motor ability as measured by the WMFT. On the MAL, participants from both groups combined showed on average a 2.2 (0.4) point increase in more-impaired arm quality of movement (QOM) (p<0.0001, d′=5.5), going from a score of 1.1 (0.5) pretreatment to 3.2 (0.6) posttreatment. Participants also displayed a 2.2 (0.6) increase in more-impaired arm amount of use (AOU) (p<0.0001, d′=3.7), starting with a score of 1.0 (0.5) pretreatment and ending with a score of 3.2 (0.7) posttreatment. On the WMFT, participants from both groups combined exhibited a 2.9 (5.6) second decrease in performance time (p<0.05, d′=0.5), going from 6.2 (7.2) second pretreatment to 3.4 (2.6) second posttreatment.

With respect to the primary question addressed in this experiment, there were no significant differences in the amount of improvement displayed by AutoCITE and standard CI therapy subjects (nonsignificant Treatment×Modality interaction). This result was confirmed by inspecting the confidence intervals around the mean change from pre- to posttreatment on each treatment outcome for each treatment modality. The confidence intervals on each treatment outcome overlapped, which suggests that automated CI therapy produces outcomes that are approximately equivalent to those of standard CI therapy. For AutoCITE and standard CI therapy subjects, mean changes in (1) MAL QOM scores were 2.0 (1.7 to 2.3) and 2.2 (2.0 to 2.5), respectively; (2) MAL AOU scores were 1.9 (1.4 to 2.4) and 2.3 (1.9 to 2.7), respectively; and (3) WMFT performance time scores were −3.3 (1.0 to −7.6) and −2.5 (1.3 to −6.2), respectively. No significant differences on these measures were found between the AutoCITE and standard CI therapy subjects before treatment.

Discussion. These results support development of a take-home automated workstation capable of delivering CI therapy without direct supervision from a therapist. Comparison of these results with those of other studies from the University of Alabama at Birmingham laboratory strongly suggests that there was no loss of effectiveness when an AutoCITE embodiment was interposed between the subject and the therapist. It was somewhat surprising that subjects who trained with an AutoCITE embodiment improved as much as subjects who received one-on-one treatment from therapists. In comparison, the AutoCITE embodiment tested has far fewer tasks available, has relatively limited shaping options, and decreases the intimacy of the interaction between patient and therapist. These potential deficiencies may have been offset by the AutoCITE embodiment's capability to provide more consistent and detailed performance feedback with each trial. The results are consistent with the hypothesis that the key therapeutic factor of CI therapy is the actual amount of concentrated use of the limb, rather than the context of the training, the type of tasks used, and the one-on-one attention of therapists. These factors appear to be of secondary importance, but work is needed in the future to evaluate this experimentally. While these aspects of the training may be important to motivate some subjects to perform the concentrated training required by CI therapy, the immediate and continuous feedback and encouraging phrases provided by the AutoCITE embodiment in these tests appeared to be sufficient to produce equivalent results to those achieved by subjects treated in a nonautomated setting. This was evident for the mild to moderately impaired subjects studied here, but further examination would be useful for testing the effectiveness of AutoCITE embodiments in more severely impaired subjects.

### EXAMPLE 2

Development of a home-based system. Several modifications to the AutoCITE embodiment of Example 1 are in order for the development of embodiments for a home-based system. The user interface will undergo continued development. For example, one iteration of the user interface will have a game-like feel that will increase adherence to the concentrated training requirement when the therapist's presence is decreased or removed entirely. Also, autoshaping algorithms will be developed or further developed. Data collected from testing subjects in an AutoCITE embodiment while supervised by a therapist will be used to develop or further develop these algorithms. These data would provide information on when and under what conditions the therapist increased or decreased the difficulty of the task.

For example, at least two aspects of autoshaping that may take place in the context of using AutoCITE embodiments are as follows. An example of the first kind would be one predicated on the mean of the last five trials or ten trials or the like. For example, when the mean score of the last five trials exceeds the mean of the previous five trials, then task difficulty is increased “one step” (as indicated in the description of various component tasks in the first Example, ways to increase task difficulty may differ for each task, i.e., be specific to each task). A general principle is that an improvement in the mean of the last five trials compared to the mean of the previous five trials indicates the subject is ready for an increase in task difficulty. An option of decreasing task difficulty also exists, e.g., if, on increasing the difficulty, the current limits of a patient's ability are reached (e.g., as indicated by a plateau or decrease in scores). Decreasing task difficulty may help a patient to remain engaged and not have the perception of being punished for previous improvements. In any case, when the mean of the last five trials is less than the mean of the previous five trials or ten trials or the like, task difficulty could be decreased.

Determining when to increase or decrease task difficulty has been previously accomplished by a therapist. In some AutoCITE embodiments, however, increasing or decreasing task difficulty is not determined by a therapist but is programmed into AutoCITE system software.

A second aspect of autoshaping is simply a part of the way in which the system operates in presenting feedback to the subject or patient. A general objective of the patient is to increase the number of repetitions of a given task trial by trial. Accordingly, after each trial, the patient may be presented on a feedback screen with a representation of his or her performance on the last trial. For example, an Arabic numeral above the bar of a histogram tells the patient whether he or she did better than on a previous trial. Or, the patient may be presented with a horizontal line of a certain color or distinguishable pattern to represent the mean of all trial scores on a certain task up to that point in time. In addition, the patient may be presented with a horizontal line of another color or distinguishable pattern to represent the best score that he or she has ever accomplished on a certain task. These structural aspects of AutoCITE embodiments facilitate implementation of autoshaping.

For some embodiments of a home-based device, the size of the workstation or workstation components will be decreased, while the flexibility of the workstation or workstation components will be increased, so that the workstation can be easily transported to, and quickly set up in, a subject's home.

A plan for how additional home-based AutoCITE embodiments will be used is as follows. As subjects receive device-based training at home, performance data will be continuously transmitted from the home-based AutoCITE embodiment to a base-station computer located at a central laboratory facility through a modem-to-modem connection or the like. This will provide access in the clinic to an online flow of data from the shaping procedures implemented during training. A therapist at the central laboratory will periodically monitor the performance data to assure adherence to protocols. A video camera will be incorporated into the home workstation that continuously records performance. If the therapist notices erratic performance on a task, he or she might investigate the performance further by examining visual images of the exercise. Upon request by a monitoring therapist, video of the trials in question will be downloaded to the base-station computer at the central laboratory via the modem-to-modem connection or the like. The therapist could then program changes in the subject's treatment protocol, or send instructional messages over the modem-to-modem connection. In these applications, a therapist could thereby monitor four (and perhaps more) subjects at a time (interacting with individual subjects as time permits and as difficulties in training emerge).

### EXAMPLE 3

Summary. In order to evaluate further the effectiveness of an AutoCITE embodiment for use when subjects are only partially supervised by therapists, twenty-seven participants with chronic stroke trained with an AutoCITE embodiment for three hours per day for ten consecutive weekdays. Participants were assigned to one of three groups in a fixed irregular order (i.e., in alternating blocks): supervision from a therapist for 100%, 50%, or 25% of training time. The effect sizes of the treatment gains for the three groups on the MAL were very large, and, for the WMFT, they were large (all P<0.001) but were not significantly different from one another. Gains were comparable to those previously reported for participants who received an equal amount of standard one-on-one CI therapy without the device. At one-month and long-term follow-up points, gains from pretreatment on the MAL were also significant (P<0.001). The results reported in this example demonstrate that AutoCITE training with greatly reduced supervision from a therapist is as effective as standard one-on-one CI therapy. (Much material of this example is from Taub et al., 2005, “AutoCITE: automated delivery of CI therapy with reduced effort by therapists,” Stroke 36: 1301-1304, which is one of three papers that constitutes U.S. patent application Ser. No. 60/692,331 entitled “Automated constraint-induced therapy extension (autocite)” by Edward Taub and Peter S. Lum, filed Jun. 20, 2005, which again is hereby incorporated by reference in its entirety.)

Introduction. Clinical trials from several laboratories have shown that survivors of stroke with chronic mild to moderately severe arm motor impairment who are given Constraint-Induced Movement therapy (CI therapy) exhibit a large increase in the amount of use of the more affected upper extremity that transfers to the life situation. CI therapy may be viewed as consisting of three main components: (1) concentrated task-based training by the technique termed “shaping” for many hours per day for a period of two or three weeks; (2) restraint of the less affected extremity for a target of 90% of waking hours; and (3) transfer techniques to effect generalization of treatment gains from the laboratory/clinic to the life situation. Clinical implementation of the technique is hindered by the large amount of costly one-on-one therapist supervision needed during the training component of the therapy.

As noted above, a device or workstation, termed an AutoCITE (automated CI therapy extension) device or workstation, automates the training portion of CI therapy and is as efficacious as standard CI therapy. AutoCITE training could potentially reduce the cost of the therapy by allowing participants to perform the training in the clinic with only partial therapist supervision. This is significant given the current health care climate of cost containment, in which the provision of services by health care payers is being cut back sharply for physical rehabilitation.

However, if an AutoCITE device is to succeed as a device that reduces the workload of clinical staff, it must be demonstrated that the effectiveness of the AutoCITE device is not diminished when participants use it with only partial supervision from therapists. AutoCITE devices have some similarities to recently developed devices in the area of robotics tele-rehabilitation (involving remote interaction between therapist and patient), virtual reality, and powered assistive devices. This study, a pioneering controlled study involving an AutoCITE device embodiment, compares the efficacy of an AutoCITE treatment against a comparable nonautomated treatment. The results of this comparison justify clinical use of such AutoCITE devices.

Apparatus. The AutoCITE embodiment used for this examples consists of a computer, eight task devices arrayed in a cabinet on four work surfaces, and an attached chair. The computer provides simple one-step instructions on a monitor that guides the participant through the entire treatment session. Completion of each instruction is verified by sensors built into the device before the next instruction is given. The participant is able to select tasks from a menu displayed on the monitor using two pushbuttons (e.g., pushbuttons 116 or 118 of FIGS. 1A, 1B and 3C). Once a task has been chosen, the appropriate work surface is manually pulled out and locked over the participant's lap. The computer program guides the participant through a set of ten 30-second trials in which the objective is to repeat a task as many times as possible. After ten trials, the task menu is displayed and the subject can select the next task. Several types of performance feedback and encouragement are provided on the computer monitor, simulating the type of verbal behavior engaged in by a therapist. The time remaining on each trial is shown on the computer monitor. The number of successful repetitions is displayed after each trial and set of trials in the form of a bar graph or histogram (e.g., as in the bar graphs on screen 120 of FIGS. 2A & 2B).

Task activities are based on tasks currently used in CI therapy. In each case, sensors measure key aspects of the task, and performance is automatically measured. The eight activities available, previously described in Example 1 (and depicted in figures) are: Reaching (FIGS. 3A to 3D), Moving Pegs (FIGS. 4A to 4C), Hand Turning (or Supination/Pronation; FIGS. 5A & 5B), Threading (FIGS. 6A & 6B), Tracing (FIGS. 7A & 7B), Object-Flipping (FIGS. 8A & 8B), Tapping (or Finger Tapping) (FIGS. 9A & 9B), and Ring-and-Arc Rotation (FIGS. 10A & 10B).

Subjects. Twenty-seven participants with mild to mild/moderate chronic stroke were recruited in sequence from a list of individuals making contact with the project to request standard CI therapy. Chronicity was for greater than one year for all individuals. Participant characteristics and initial motor scores are presented in Table 2. All participants could extend at least twenty degrees at the wrist and ten degrees at each of the finger joints while at the same time having greatly reduced use of the extremity in ADLs. Participants were excluded if they had balance problems, excessive pain in any joint of the extremity, were too high-functioning (>2.5 MAL score), or had uncontrolled medical problems, excessive spasticity, or cognitive problems as indicated by a score on the Mini-Mental State Examination of <24 (as noted in Example 1). The protocol was approved by the local institutional review board and each patient signed an informed consent form.

TABLE 2
Participant Characteristics and Initial Motor Scores

| | Percentage Supervision | | |
|---|---|---|---|
| Characteristic | 100% (n = 9) | 50% (n = 9) | 25% (n = 9) |
| Age | 56.3 ± 10.5 | 64.5 ± 8.1 | 59.6 ± 12.1 |
| Chronicity (y) | 5.3 ± 3.7 | 5.7 ± 4.9 | 5.5 ± 2.7 |
| Male/female | 7/2 | 6/3 | 8/1 |
| Paresis (right/left) | 6/3 | 6/3 | 3/6 |
| Dominance (r/l) | 9/0 | 8/1 | 7/2 |
| MAL (max = 5) | 1.1 ± 0.42 | 1.3 ± 0.53 | 1.13 ± 0.60 |
| WMFT FA (max = 4) | 2.8 ± 0.50 | 2.7 ± 0.33 | 2.7 ± 0.29 |
| WMFT PT (s) | 3.7 ± 1.4 | 3.5 ± 1.6 | 3.9 ± 1.3 |

Note:
Values are mean ± SDs. None of the between group differences were significant (medium P = 0.55; range = 0.26-0.98).

Procedures. All subjects were asked to wear a padded safety mitt on their less affected hand for a target of 90% of waking hours over a two-week period. On each weekday, subjects received training using an AutoCITE device (FIG. 1A) for 3 hours. Participants were assigned to 50% or 25% supervision from the therapist in a fixed irregular order (i.e., in alternating blocks). Participants who received 100% supervision had been treated and tested previously (see Example 1). A heavy floor-to-ceiling curtain was placed between the AutoCITE device and the therapist's desk. The therapist set-up the participant on the AutoCITE device and then retreated behind the floor-to-ceiling curtain while the participant performed the tasks. The therapist only returned to change tasks, change the difficulty of tasks, or when a participant requested assistance (which occurred 1.7 times per hour). In the remainder of the allotted interaction time for that patient, the therapist supplemented the encouragement and feedback provided on the screen of a computer monitor (e.g., as on screen 120 of FIGS. 2A & 2B).

The difficulty of the tasks was varied using shaping guidelines derived from previous CI therapy research. Shaping involved progressively increasing the difficulty of a task in small steps and providing frequent positive feedback and encouragement. Testing was performed just before and after the intervention. The tests included the WMFT and the MAL. The WMFT measures performance time and functional ability on fifteen tasks and the strength of shoulder flexion/elbow extension and grip in two tasks. Functional ability is rated from videotape by masked raters trained to a high level of reliability (r>0.9). The MAL is a structured interview that provides a measure of spontaneous use of the more affected upper extremity in the life situation. It obtains information on how much (AOU scale) and how well (QOM scale) the more impaired arm was used for accomplishing important ADLs. The version used here had fourteen items; only the QOM scale is reported because QOM scale and AOU scale scores were highly correlated (r=0.91). Details of aspects of the treatment and testing procedures are also described elsewhere (see Example 1 above).

Data Analysis. Group differences for categorical variables (gender, side of dominance, and paresis) were tested by X² (Chi-square); age, chronicity, and initial motor scores were tested using univariate ANOVA. Repeated-measures ANOVAs were used to evaluate the effect of treatment. Significant results from the ANOVAs for the MAL were followed by pair-wise comparisons using Tukey's tests. The magnitude of the treatment effects was indexed using d′, a within-subjects measure of effect size. By the standards of the meta-analysis literature, small, medium, and large d′ values are 0.14, 0.35, and 0.57, respectively. Individual test scores that were greater than three SDs from the mean were considered outliers. On this basis, the WMFT performance time scores of two participants were excluded. Follow-up MAL data were excluded from two subjects who experienced serious medical problems that impeded their physical activity for extended periods shortly after the end of treatment. The medical problems were judged (by a collaborating physician) to be unrelated to participation in this study.

Results and Discussion. There were no significant differences before treatment between the 100%, 50%, and 25% supervision groups on the MAL and WMFT or in the demographic or stroke characteristics measured (Table 2). The time logging procedure used by the experimenter was successful in controlling the amount of supervision: average supervision times were 50.2±2.5% and 25.3±2.3% in the two reduced supervision groups, respectively. Furthermore, the intensity of training did not differ significantly between groups; mean tasks per hour for the 100%, 50%, and 25% supervision groups were 3.5±1.7, 3.5±0.67, and 3.2±0.96, respectively.

Participants in all three groups combined showed significant changes in real-world arm use over all post-treatment testing occasions (MAL: P<0.001). At post-treatment the mean gain on the MAL was 2.0±0.54 points (P<0.001, d′=3.7). This very large improvement was retained at one-month follow-up (Table 3). At long-term follow-up, there was 16% decrement from post-treatment (−0.5±0.54, P<0.05). Relative to pretreatment, however, the gains retained at long-term follow-up were still large (Table 3). Participants also showed large improvements in arm motor ability (WMFT; Table 3).

TABLE 3
Treatment Gains on Motor Tests

| | AutoCITE (% Supervision) | | | | Standard |
|---|---|---|---|---|---|
| Test | 100% | 50% | 25% | Comb'd | CI Therapy |

Changes from Pretreatment to Post-treatment:

| | | | | | |
|---|---|---|---|---|---|
| MAL | 2.0 ± 0.37 | 2.0 ± 0.48 | 1.9 ± 0.74 | 2.0 ± 0.54^{†} | 1.9 ± 0.6^{†} |
| WMFT FA | 0.1 ± 0.11 | 0.2 ± 0.10 | 0.2 ± 0.17 | 0.1 ± 0.14^{†} | 0.2 ± 0.3* |
| WMFT PT | −1.0 ± 0.37 | −0.7 ± 1.08 | −0.9 ± 0.76 | −0.9 ± 1.0^{†} | −2.3 ± 2.3^{†} |

Changes from Pre- to One-month Follow-up:

| | | | | | |
|---|---|---|---|---|---|
| MAL | 1.5 ± 0.37 | 2.0 ± 0.40 | 2.0 ± 0.61 | 1.8 ± 0.67^{†} | 1.9 ± 0.7^{†} |

Changes from Pre- to Long-Term Follow-up:

| | | | | | |
|---|---|---|---|---|---|
| MAL | 1.4 ± 0.65 | 1.6 ± 0.49 | 1.5 ± 0.85 | 1.5 ± 0.66^{†} | 1.2 ± 0.9^{†} |

Values are mean ± SD.
None of the between group differences in improvement from pretreatment (i.e., group × testing occasion effects) were significant. Significance levels are noted for change from pretreatment within all AutoCITE groups combined and a previously run CI therapy group (n = 21), which received one-on-one therapist-administered training and is included here for ease of reference. Long-term follow-up was obtained >6 months after treatment for all individuals in each of the groups.
*P < 0.05;
^{†}P < 0.001.

Importantly, with respect to the primary question addressed in this experiment, there were no significant differences in treatment outcome among subjects that received 100%, 50%, and 25% supervision (Table 3). The fact that no significant differences were found between the 100% and reduced supervision groups does not preclude the possibility that a minimal clinically important difference (MCID) existed, but was not detected because of the sample size. The MAL, which is a measure of real-world arm use, has been used extensively in CI therapy research and the MCID has been defined by Van der Lee et al. to be values >10% of full scale, or 0.5 points. Power to detect a reduction in effectiveness larger than the MCID at post-treatment in the 50% and 25% supervision groups relative to the 100% group was adequate (>0.84). Furthermore, differences between the 100% and partial supervision groups in gains from pretreatment on the MAL were less than the MCID at post-treatment and both follow-ups (Table 3).

Work presented in this Example represents a successful step toward automation of the training component of CI therapy. In Example 1, AutoCITE training when supervised 100% of the time by a therapist was shown to be as effective as standard one-on-one CI therapy. This Example 3 demonstrates that there was no loss of effectiveness when AutoCITE training was supervised for only 50% or 25% of the time. These results support the position that with AutoCITE training, one therapist may be able to treat multiple patients at one time.

### EXAMPLE 4

Summary. This example reports on study having the goal to evaluate the effectiveness of AutoCITE training when supervised remotely and with only intermittent interaction with a therapist. Seven participants with chronic stroke trained with AutoCITE for three hours per day for ten consecutive weekdays. The therapist supervised the training from a different room in the clinic using remote control of the AutoCITE computer and tele-conferencing equipment when needed. Treatment gains on the MAL were very large (P<0.001, d′=3), while gains on the WMFT and the Jebsen-Taylor Test of Hand Function were large (P<0.05, d′>0.9). Gains were comparable in size to those previously reported for participants who received equal intensities of directly supervised AutoCITE training or standard one-on-one CI therapy without the device. (Much material of this example is from P S Lum, G Uswatte, E Taub, P Hardin and V W Mark, in press, “A tele-rehabilitation approach to delivery of Constraint-Induced Movement therapy,” Journal of Rehabilitation Research and Development).

Introduction. Several clinical trials have shown that the application of CI therapy in patients with chronic stroke with mild to moderately severe motor impairment produces a large increase in the amount of use of the more affected upper extremity that transfers to the life situation. CI therapy as practiced generally consists of three main components: 1) concentrated task-based training (usually by shaping) of the more affected upper extremity for many hours per day for a period of consecutive weeks, 2) a package of transfer techniques designed to effect generalization of treatment gains from the laboratory/clinic to the life situation, and 3) restraint of the less-affected extremity for a target of 90% of waking hours. Clinical implementation of the technique is hindered by the large amount of one-on-one therapist supervision needed during the training component of the therapy, and the trend of decreasing reimbursable therapist-patient contact time. Even if the treatment were readily available in the clinic, transportation issues in rural areas would limit access to the treatment. A tele-rehabilitation approach to delivery of CI therapy could greatly decrease the cost of the treatment and increase access for many patients who could benefit from it.

As noted in Examples 1 and 3, above, the AutoCITE device automates the training portion of CI therapy, thereby reducing the amount of therapist effort needed to provide CI therapy and potentially overcoming the key obstacle to widespread use of CI therapy. Previous work established that in-clinic AutoCITE training, when supervised 100% of the time by a therapist, is as effective as one-on-one training from a therapist as is done in standard CI therapy. A subsequent study showed that there was no loss of efficacy when the AutoCITE training was supervised only 50% or 25% of the time (see Example 3). In this Example, we simulated the use of AutoCITE in a tele-rehabilitation setting and tested the efficacy of AutoCITE training when supervised remotely and intermittently.

The potential impact of tele-rehabilitation approaches to movement training has been noted, but a review of the literature finds very few examples of formal patient testing (and none with AutoCITE embodiments). The basic feasibility of remote retraining of arm movement in stroke patients has been demonstrated with JAVA-Therapy software. A participant trained at home using the computer mouse and keyboard as input devices, interacting with a web-based library of games and progress charts. Tasks included fast-as-possible finger tapping and targeted point-to-point reaching movements using the mouse. Programs automatically recorded participant performance and sent this information over the web to a central computer. The participant improved in terms of movement parameters over the course of several training sessions.

In another laboratory, more formal patient testing has been performed on a virtual reality (VR)-based tele-rehabilitation system. In this system, the therapist in the clinic specifies a task such as moving the hand through a doughnut. A three-dimensional image of a doughnut appears on the participant's computer screen. A magnetic tracker records the arm movement and projects over the doughnut image the trajectories taken during the task practice. Five participants trained at home an hour each day for four weeks. Gains in a motor impairment scale were noted after training.

In-clinic testing of a VR-based hand training system has been reported. The input devices used were the CyberGlove (Immersion Technologies) for measuring movement of the digits during range-of-motion tasks, and the Rutgers Master II-ND glove for simulating interactions with virtual objects. Four participants trained in the clinic for two hours per day, five days a week for three weeks. Gains in movement parameters were noted and two participants had gains in the Jebsen-Taylor Test of Hand Function. In another related study, the intensity of training was altered to daily training for 3.5 hours per day for two weeks. All three participants had gains in movement parameters and two patients had gains in the Jebsen-Taylor Test. A tele-rehab version of this system that incorporates games and exercises (e.g., peg board) has been reported; however no clinical testing has been reported. Transfer of treatment gains to the life setting was not assessed in any of the above studies.

While these studies are promising, this example reports on the first implementation and testing of a tele-rehabilitation approach based directly on CI therapy. CI therapy is a treatment for chronic stroke that has gone through clinical trials and has been proven efficacious for stroke rehabilitation. If remote AutoCITE training is as efficacious as CI therapy when supervised in person by a therapist, then tele-rehabilitation via AutoCITE or similar devices would be appropriate and would both allow application of the treatment in a cost-effective manner and increase access to CI therapy for many survivors of stroke.

Methods—AutoCITE: An AutoCITE embodiment of this example incorporates a computer and eight task devices arrayed in a cabinet on four work surfaces (see 104, 106, 108, and 110 of FIG. 1A). The computer provides simple one-step instructions on a monitor 122 that guides the participant through the entire treatment session. Completion of each instruction is verified by sensors built into the device before the next instruction is given. The participant controls two pushbuttons 116 and 118 that are used when choice of task is to be made; they thus allow the participant to control the flow of the session. Once a task has been chosen, the appropriate work surface is adjusted in height automatically and is manually pulled out and locked over the participant's lap. The computer program guides the participant through a set of ten 30-second trials. The individual is instructed to repeat a task as many times as possible within each trial. After each set of trials is completed, the task menu is displayed making it possible for the subject to select the next task. Several types of performance feedback are provided. The time remaining on each trial is indicated on the computer monitor by a circle (e.g., circle 303 of FIGS. 3A & 3B) that is progressively filled in as time elapses, and an audible beep is produced when a repetition is completed. The number of successful repetitions is displayed after each trial in the form of a bar graph (e.g., bar graphs of which bar 202 of FIG. 2A or bar 204 of FIG. 2B are a part). Comments are provided by the computer based upon current task performance: enthusiastic approval when performance is improved and encouragement when it is not. Leaning forward with the torso during training is detected by a sensor that registers the flex of the chair and activates a buzzer when a criterion value is exceeded.

In some embodiments, the activities are based upon tasks currently used in CI therapy and collectively address shoulder, elbow, wrist, hand and finger function. Sensors measure key aspects of the task, and performance is automatically measured as the number of completed repetitions in 30 seconds.

Tasks of one embodiment include those previously described in part in Example 1, such as: 1) Reaching—This task involves successive tapping of a button just in front of the body and a target circle located on a touch screen. Task difficulty can be increased by moving the monitor further away or higher. 2) Tracing—The touch screen presents large block letters that the participant has to trace with his or her fingertip or other portion of the hand. Difficulty is increased by decreasing the width of the letters, increasing the distance of the monitor from the participant, or increasing the height of the monitor. 3) Moving Pegs—The task is to move three pegs from a row of holes to a mirror-image row of same-sized holes on the other side of the board and then back again, etc. Peg sizes can be selected that require cylindrical grasp, three-jaw-chuck or thumb-index finger pinch. 4) Hand Turning or Supination/Pronation—Participants grasp a cylindrical handle that is mounted to a shaft and bearing assembly that allows rotation about an axis through the forearm. Participants rotate the handle back and forth between two specified angles. Difficulty is increased by requiring larger excursions of supination and pronation. 5) Threading—The task is to thread a shoelace through holes in a series of posts. This requires pushing the tip of the shoelace through a hole, reaching around to the other side of the post, re-grasping the tip and pushing it through the next hole, and so on. The hole openings are funneled on one side of the posts but not on the other so that difficulty depends on the direction of threading. 6) Ring-and-arc rotation—A ring is attached to the end of a long arm that is mounted to a shaft and bearing assembly that allows rotation of the arm in the frontal plane between two fixed mechanical stops. The task is to grasp the ring and rotate the arm of the device from one stop to another. Difficulty is graded by increasing the length of the arm of the device. 7) Fingertapping—The task is to tap one finger as fast as possible while keeping the other fingers in contact with fingertip pads and the palm in contact with a palm rest. To increase difficulty, the palm rest can be moved downwards relative to the fingertip pads so that the task must be completed with the fingers in a more extended position. 8) Object-flipping—The goal is to repeatedly flip over a rectangular block while keeping it on a work surface. To increase difficulty, progressively smaller or larger blocks (depending on the nature of the participant's deficit) are used.

Methods—Participants: Seven patients with chronic stroke were recruited to participate. All were greater than twelve months post-stroke. All could extend at least twenty degrees at the wrist and ten degrees at each of the metacarpophalangeal and interphalangeal joints while at the same time having greatly reduced use of the extremity in the activities of daily living. Participants were excluded if they had balance problems, excessive pain in any joint of the extremity, uncontrolled medical problems, excessive spasticity, or cognitive problems as indicated by a score on the Mini-Mental State Exam of less than 24. The protocol was approved by the local Institutional Review Board and each patient signed an informed consent form.

Seven participants completed the training and post-treatment evaluations. The average age was 42.2±17.1 years and the average chronicity was 9.9±17.7 years. Three participants had right paresis and four had left paresis. Five participants were right hand dominant and two were left hand dominant. Three males and four females were tested. The average baseline score on the MAL was 1.5±0.4, while average scores on the WMFT were 2.8±0.6 for the functional ability scale and 3.9±2.4 seconds for performance time. The average baseline score on the Jebsen-Taylor Test of Hand Function was 43.7±28.4 seconds.

Methods—Procedures. All participants were asked to wear a padded safety mitt on their less-affected limb for a target of 90% of waking hours over a two-week period. Each weekday during this period, participants received training by shaping using an AutoCITE workstation for three hours while testing and record keeping activities usually took another half hour. To simulate a tele-rehabilitation setting, the therapist would setup the participant in an AutoCITE workstation and then retreat to a different room on the same floor. Video conferencing equipment provided the therapist with video of the training activity and a two-way flow of audio between therapist and participant. This equipment was composed of two laptop computers (APPLE COMPUTER INC.) that were connected via the hospital's local area network, one laptop with the participant and the other in the therapist's location. Each laptop was equipped with a firewire video camera (iSight, APPLE COMPUTER INC.) with a built-in microphone. The data flow was handled with iChat AV software (APPLE COMPUTER INC.). Once the session began, the therapist could control the amount of interaction by muting or leaving open the microphone on his end. A dedicated Ethernet line linked the AutoCITE computer to a second computer monitor and keyboard in the therapist's room. This allowed the therapist to see what was being displayed on the AutoCITE computer monitor and to control the AutoCITE computer from his or her location.

The therapist was experienced in the delivery of CI therapy and used the following guidelines when remotely supervising the treatment. 1) At the end of one task and the beginning of the next task, the therapist would give the participant feedback on their performance including quality of movement on the previous task and if needed, provide instructions and coaching for the ensuing task. 2) If a participant did particularly well on a trial, the therapist would reinforce the AutoCITE's positive comments (e.g., “Great work,” or “First class”). If the participant struggled on a trial, the therapist would add encouraging words (e.g., “That's fine. Just keep it up.”) or suggest strategies for improving performance. 3) If there was a technical problem with the operation of the AutoCITE, the therapist would communicate with the participant about the problem, either troubleshooting the problem with them, or explaining what could be done or was being done to solve the problem. 4) If the participant used the audio intercom to address the therapist regarding a concern, ask a question or comment, the therapist would communicate with the participant. This happened very rarely; communication was almost always initiated by the therapist. 5) For the remainder of the treatment session the therapist's microphone was muted so as to not distract the participant. The amount of time that the therapist's microphone was activated was recorded in the last five participants and this was used to log the amount of therapist-participant communication time. The intercom was kept on when the therapist left his room to interact with the participant in person.

Testing was carried out just before and after the intervention. The tests included the WMFT, the Jebsen-Taylor Test of Hand Function and the MAL. The WMFT measures performance time and functional ability on fifteen tasks and the strength of shoulder flexion/elbow extension and grip in two tasks. The Jebsen-Taylor test measures performance time for several hand tasks such as picking up small objects and writing. The MAL is a structured interview that provides a measure of spontaneous use of the more-affected upper extremity in the life situation. It obtains information about fourteen important ADLs from such areas as feeding, dressing and grooming, providing scores on an AOU scale, and a QOM scale. Because there is a high correlation between scores on these two scales, only the MAL QOM scale is reported here. The MAL was repeated one month after the end of treatment, and a long-term follow-up was conducted six-twelve months later.

Score changes between test occasions were tested for significance with paired t-tests. The magnitude of the treatment effects was indexed using d′, a within-subjects measure of effect size. By the standards of the meta-analysis literature, small, medium and large d′ values are 0.14, 0.35, and 0.57, respectively. Mean gains were compared to data from previous experiments on directly supervised AutoCITE training and standard CI therapy delivered by a therapist.

Results. Participants showed significant gains in both arm function and real-world arm use after treatment. The pre- to post-treatment gain on the MAL was 2.1±0.7 points (P<0.001, d′=3.0). The change in MAL scores between post-treatment and the one-month follow-up was not significant (mean change=0.0±0.2, P>0.87). There was a slight decline in MAL scores between the one-month and long-term follow-up, but this change was not statistically significant (mean change=−0.3±0.9, P>0.39). Scores on the WMFT also improved significantly at post-treatment. The mean change on WMFT performance time (i.e., WMFT PT) was −0.9±0.9 seconds (P<0.05, d′=1.0), and the improvement on WMFT functional ability (i.e., WMFT FA) was 0.2±0.2 (P<0.05, d′=1.2). Jebsen-Taylor scores improved significantly after treatment (mean change=−13.5±14.6 sec, P<0.05, d′=0.9). By the standards of the meta-analysis literature, all of the treatment effects can be considered large.

In each daily three-hour training session, the therapist spent an average of 18.1% of the time communicating with the participant. Approximately once per hour the participant encountered a problem that benefited from the therapist's presence; approximately 2% of the total training time was spent in direct face-to-face contact with the participant. Virtually all the in-person contacts involved equipment problems (often dropping one of the test objects being manipulated); these would be corrected in an improved version of the present prototype device.

Discussion. The gains in motor ability (WMFT) and real-world function (MAL) for individuals treated using AutoCITE with remote supervision were comparable to the gains previously reported for chronic stroke subjects who received an equal amount of directly-supervised AutoCITE training or standard one-on-one CI therapy (see also Table 4). These previously tested individuals were recruited from the same pool, under the same inclusion and exclusion criteria, and were treated and tested in the same laboratory as were the participants in this study. A potentially confounding factor in this comparison is the fact that the participants in our subject pool were significantly younger (age=42.2±17.1) than those in the group that received directly supervised AutoCITE training (age=60.1±10.6). The computerized performance feedback might be more effective in younger populations due to a greater familiarity with computer technology compared to older participants, who might be more motivated by direct one-on-one contact from therapists. However, when the participants were divided into young and old groups, the younger participants (n=3, age=24.9±7.7) did no better than the older participants (n=4, age=55.2±4.3) on any of the outcome measures (P>0.4).

TABLE 4
Treatment Gains on Motor Tests

| | AutoCITE | | Std CI |
|---|---|---|---|
| | Remote | Direct | Therapy |
| Test | Supervision (n = 7) | Supervision (n = 27) | (n = 21) |

Changes from Pretreatment to Post-treatment:

| | | | |
|---|---|---|---|
| MAL | 2.1 ± 0.7^{†} | 2.0 ± 0.54^{†} | 1.9 ± 0.6^{†} |
| WMFT FA | 0.2 ± 0.2* | 0.1 ± 0.14^{†} | 0.2 ± 0.3* |
| WMFT PT | −0.9 ± 0.9* | −0.9 ± 1.0^{†} | −2.3 ± 2.3^{†} |

Changes from Pre- to One-month Follow-up:

| | | | |
|---|---|---|---|
| MAL | 2.1 ± 0.7^{†} | 1.8 ± 0.67^{†} | 1.9 ± 0.7^{†} |

Changes from Pre- to Long-Term Follow-up:

| | | | |
|---|---|---|---|
| MAL | 1.8 ± 1.1^{§} | 1.5 ± 0.66^{†} | 1.2 ± 0.9^{†} |

Values are mean ± standard deviation. Significance levels are noted for change from pre-treatment values. For comparison, data is included from a previously run group of subjects that received directly supervised AutoCITE training, and a previously run CI therapy group that received one-on-one therapist administered training.
*P < 0.05;
^{§}P < 0.01
^{†}P < 0.001.

Previous research has indicated that a key therapeutic factor of CI therapy is the amount of concentrated use of the limb that patients are induced to carry out. The rate at which training proceeded with the remote AutoCITE participants here was self-selected and was greater than when the rate was controlled by a therapist based on patient preference and apparent fatigue. This indicates that AutoCITE embodiments have the ability to keep participants focused and motivated so that a high rate of practice can be maintained throughout treatment. This is presumably achieved by provision of immediate and detailed feedback on performance during and after each trial on an impersonal basis by a device. It has been our clinical observation that this arrangement is, contrary to our expectations, more effective in motivating attempts to improve performance than AutoCITE training with a therapist present or when treatment is carried out by a therapist without the use of such a device. Another important factor relates to the AutoCITE design, which promotes proper performance of the tasks and allows the difficulty to be incremented in a manner similar to standard CI therapy. In these regards, CI therapy delivered on a remote, automated basis does not appear to impose any limitations on the effectiveness of treatment.

Because these results are based on a simulated tele-rehabilitation setting, similar gains may not be achievable with a comparable remote device placed in the home. The AutoCITE workstation room was a controlled environment with none of the distractions that might interrupt home training. The speed of the communication link between the AutoCITE workstation and the therapist station was many times faster than is often possible in home training, where the communication link will most likely be via regular telephone lines. Unless a broadband connection were available, the quality of the video feed at the therapist station will be poor compared to what was available in this study. Nevertheless, we expect these factors will be minor as long as the targeted amount of training is achieved.

Some basic embodiments of an AutoCITE workstation differ from other tele-rehabilitation devices in at least the following ways. 1) Some basic embodiments of an AutoCITE workstation use task devices, motivational feedback, and shaping rules that are based on CI therapy. 2) Some basic embodiments of an AutoCITE workstation facilitate a therapy approach similar to the JAVA-Therapy approach, but while input devices for JAVA-therapy have not been developed other than the standard keyboard, mouse and joystick, basic embodiments of an AutoCITE workstation incorporate an array of task devices that mimic important movement components of activities of daily living. 3) VR-based devices use sensors to record the activity of the arm (i.e., CyberGlove, 3-D magnetic tracker), and the movement kinematics from these sensors are used to control a virtual image of the arm or hand. A video display presents the virtual arm or hand along with the task requirements. Actuated devices (e.g., Rutgers Master II-ND glove) allow simulation of force interactions with virtual objects on the display. In contrast to this VR-based approach, some basic embodiments of an AutoCITE workstation rely on an array of simple task devices. Instead of virtual objects, real objects are used. Instead of watching a virtual image of the arm, the subject watches his real arm. The key performance variables are measured via sensors built into the task devices. Thus, some basic embodiments of an AutoCITE workstation can be much less costly compared to current VR-based devices. While the use of VR-based systems may eventually prove to have advantages relative to devices such as those represented by some basic embodiments of an AutoCITE workstation, this remains to be demonstrated. Commercial implementation would favor the simplest, least-expensive device that facilitates the required training.

These results justify continued investigation into tele-rehabilitation approaches for delivery of CI therapy (e.g., through use of AutoCITE embodiments). In addition to an AutoCITE workstation designed for use in the clinic (as reported in this and previous examples), this example envisions portable embodiments that can be used at home with remote supervision from therapists. Achieving the treatment outcomes of CI therapy in a home-based training protocol that incorporates remote supervision with only intermittent interaction with therapists would reduce the cost of the therapy and greatly expand access to CI therapy for stroke survivors.

Following long-standing patent law convention, the terms “a” and “an” mean “one or more” when used in this application, including the claims. Even though embodiments have been described with a certain degree of particularity, it is evident that many alternatives, modifications, and variations will be apparent to those skilled in the art in light of the present disclosure. Accordingly, it is intended that all such alternatives, modifications, and variations which fall within the spirit and scope of the described embodiments be embraced by the defined claims.

We claim:

1. A workstation for automated constraint-induced movement therapy (i.e., automated CI therapy), the workstation comprising:
a cabinet comprising an extensible work surface for positioning a task input device;
a computer;
a control input device for receiving workstation control parameter data, for transforming the received workstation control parameter data, and for transmitting the transformed workstation control parameter data to the computer;
a task input device for receiving task performance data, for transforming the received task performance data, and for transmitting the transformed task performance data to the computer;
a control device for receiving from the computer further transformed workstation control parameter data (electronic instructions for control of the workstation) and for controlling the workstation using the further transformed workstation control parameter data; and
a data feedback device for receiving from the computer further transformed task performance data and for displaying the further transformed task performance data in a readable format;
wherein the computer further transforms the transformed workstation control parameter data received from the control input device into further transformed workstation control parameter data (electronic instructions for control of the workstation), and
wherein the computer exports the further transformed workstation control data to a control device for control of the workstation by the control device, and
wherein the computer further transforms the transformed task performance data received from the task input device into further transformed task performance data for display by the data feedback device in a readable format.

2. The workstation of claim 1 further comprising a chair.

3. The workstation of claim 2 wherein the chair includes a locking mechanism that maintains the chair a prescribed distance from the cabinet.

4. The workstation of claim 1 wherein the task input device receives performance data for an automated CI therapy task that is selected from the group consisting of: Reaching; Peg Moving; Hand Turning; Threading; Tracing; Flipping; Finger Tapping; and Ring-and-Arc Rotation.

5. The workstation of claim 1 wherein the task input device is selected from the group consisting of: a touch screen monitor that records location of touch by a hand part; a peg board that records peg movement; a handle mounted to a shaft and bearing assembly that records rotation of the handle about an axis through a fixed arc; an assembly of posts that records threading of one or more posts with a string; a touch screen monitor that records location of tracing by a hand part; a camera that records color or pattern changes in a field; a sensor for a finger that records tapping of a finger; and a sensor on an arm that is rotationally secured at one end and where the sensor records rotation of the arm through an arc.

6. The workstation of claim 1 wherein the computer further transforms the transformed task performance data received from the task input device into autoshaping response data for display in a readable format by the data feedback device.

7. A method of tele-rehabilitation, the method comprising:
remotely monitoring further transformed task performance data from a workstation being used for automated constraint-induced movement therapy (i.e., automated CI therapy), wherein the workstation comprises:
a cabinet comprising an extensible work surface for positioning a task input device;
a computer;
a control input device for receiving workstation control parameter data, for transforming the received workstation control parameter data, and for transmitting the transformed workstation control parameter data to the computer;
a task input device for receiving task performance data, for transforming the received task performance data, and for transmitting the transformed task performance data to the computer;
a control device for receiving from the computer further transformed workstation control parameter data (electronic instructions for control of the workstation) and for controlling the workstation using the further transformed workstation control parameter data;
a data feedback device for receiving from the computer further transformed task performance data and for displaying the further transformed task performance data in a readable format;
wherein the computer further transforms the transformed workstation control parameter data received from the control input device into further transformed workstation control parameter data (electronic instructions for control of the workstation), and
wherein the computer exports the further transformed workstation control data to a control device for control of the workstation by the control device, and
wherein the computer further transforms the transformed task performance data received from the task input device into further transformed task performance data for display by the data feedback device in a readable format; and
remotely providing data responsive to the further transformed task performance data from the workstation.

8. The method of claim 7 wherein the data responsive to the further transformed task performance data comprises data for instructional or shaping messages.

9. The method of claim 7 wherein the task input device receives performance data for an automated CI therapy task that is selected from the group consisting of: Reaching; Peg Moving; Hand Turning; Threading; Tracing; Flipping; Finger Tapping; and Ring-and-Arc Rotation.

10. The method of claim 7 wherein the task input device is selected from the group consisting of: a touch screen monitor that records location of touch by a hand part; a peg board that records peg movement; a handle mounted to a shaft and bearing assembly that records rotation of the handle about an axis through a fixed arc; an assembly of posts that records threading of one or more posts with a string; a touch screen monitor that records location of tracing by a hand part; a camera that records color or pattern changes in a field; a sensor for a finger that records tapping of a finger; and a sensor on an arm that is rotationally secured at one end and where the sensor records rotation of the arm through an arc.

11. The method of claim 7 wherein the computer further transforms the transformed task performance data received from the task input device into autoshaping response data for display in a readable format by the data feedback device.

12. The method of claim 7 wherein workstation control parameter data is suitable for remotely providing therapy via the workstation to a patient who has suffered a stroke, traumatic brain injury (TBI), brain resection, Multiple Sclerosis or spinal cord injury (SCI).

13. The method of claim 7 wherein workstation control parameter data is suitable for remotely providing therapy via the workstation to a patient for whom continuous one-on-one supervision by a therapist is not practicable or financially feasible.

14. A computer readable medium having computer-executable instructions for performing acts comprising:
receiving task performance data from a task input device;
transforming the received task performance data; and
transmitting the transformed task performance data to a computer, wherein the computer further transforms the transformed task performance data received from the task input device into further transformed task performance data for display by a data feedback device in a readable format,
wherein the task input device is part of a workstation comprising:
a cabinet comprising an extensible work surface for positioning the task input device;
the computer;
a control input device for receiving workstation control parameter data, for transforming the received workstation control parameter data, and for transmitting the transformed workstation control parameter data to the computer;
the task input device for receiving task performance data, for transforming the received task performance data, and for transmitting the transformed task performance data to the computer;
a control device for receiving from the computer further transformed workstation control parameter data (electronic instructions for control of the workstation) and for controlling the workstation using the further transformed workstation control parameter data; and
the data feedback device for receiving from the computer further transformed task performance data and for displaying the further transformed task performance data in a readable format;
wherein the computer further transforms the transformed workstation control parameter data received from the control input device into further transformed workstation control parameter data (electronic instructions for control of the workstation), and
wherein the computer exports the further transformed workstation control data to a control device for control of the workstation by the control device.

15. The computer readable medium of claim 14 wherein the task input device receives performance data for an automated CI therapy task that is selected from the group consisting of: Reaching; Peg Moving; Hand Turning; Threading; Tracing; Flipping; Finger Tapping; and Ring-and-Arc Rotation.

16. The computer readable medium of claim 14 wherein the task input device is selected from the group consisting of: a touch screen monitor that records location of touch by a hand part; a peg board that records peg movement; a handle mounted to a shaft and bearing assembly that records rotation of the handle about an axis through a fixed arc; an assembly of posts that records threading of one or more posts with a string; a touch screen monitor that records location of tracing by a hand part; a camera that records color or pattern changes in a field; a sensor for a finger that records tapping of a finger; and a sensor on an arm that is rotationally secured at one end and where the sensor records rotation of the arm through an arc.

17. A computer readable medium having computer-executable instructions for performing acts further comprising:
remotely monitoring further transformed task performance data from a workstation being used for automated constraint-induced movement therapy (i.e., automated CI therapy), wherein the workstation comprises:
a cabinet comprising an extensible work surface for positioning a task input device;
a computer;
a control input device for receiving workstation control parameter data, for transforming the received workstation control parameter data, and for transmitting the transformed workstation control parameter data to the computer; and
a task input device for receiving task performance data, for transforming the received task performance data, and for transmitting the transformed task performance data to the computer;
a control device for receiving from the computer further transformed workstation control parameter data (electronic instructions for control of the workstation) and for controlling the workstation using the further transformed workstation control parameter data;
a data feedback device for receiving from the computer further transformed task performance data and for displaying the further transformed task performance data in a readable format;
wherein the computer further transforms the transformed workstation control parameter data received from the control input device into further transformed workstation control parameter data (electronic instructions for control of the workstation), and
wherein the computer exports the further transformed workstation control data to a control device for control of the workstation by the control device, and
wherein the computer further transforms the transformed task performance data received from the task input device into further transformed task performance data for display by the data feedback device in a readable format; and
remotely providing data responsive to the further transformed task performance data form the workstation.

18. The computer readable medium of claim 17 wherein the data responsive to the further transformed task performance data comprises data for instructional or shaping messages.

19. The computer readable medium of claim 17 wherein the task input device receives performance data for an automated CI therapy task that is selected from the group consisting of: Reaching; Peg Moving; Hand Turning; Threading; Tracing; Flipping; Finger Tapping; and Ring-and-Arc Rotation.

20. The computer readable medium of claim 17 wherein the task input device is selected from the group consisting of: a touch screen monitor that records location of touch by a hand part; a peg board that records peg movement; a handle mounted to a shaft and bearing assembly that records rotation of the handle about an axis through a fixed arc; an assembly of posts that records threading of one or more posts with a string; a touch screen monitor that records location of tracing by a hand part; a camera that records color or pattern changes in a field; a sensor for a finger that records tapping of a finger; and a sensor on an arm that is rotationally secured at one end and where the sensor records rotation of the arm through an arc.

21. The computer readable medium of claim 17 wherein the computer further transforms the transformed task performance data received from the task input device into autoshaping response data for display in a readable format by the data feedback device.

22. A tele-rehabilitation system for effecting automated constraint-induced movement therapy (i.e., automated CI therapy), the system comprising:
a device for remotely receiving further transformed task performance data from a workstation being used for automated CI therapy, wherein the workstation comprises:
a cabinet comprising an extensible work surface for positioning a task input device;
a computer;
a control input device for receiving workstation control parameter data, for transforming the received workstation control parameter data, and for transmitting the transformed workstation control parameter data to the computer; and
a task input device for receiving task performance data, for transforming the received task performance data, and for transmitting the transformed task performance data to the computer;
a control device for receiving from the computer further transformed workstation control parameter data (electronic instructions for control of the workstation) and for controlling the workstation using the further transformed workstation control parameter data;
a data feedback device for receiving from the computer further transformed task performance data and for displaying the further transformed task performance data in a readable format;
wherein the computer further transforms the transformed workstation control parameter data received from the control input device into further transformed workstation control parameter data (electronic instructions for control of the workstation), and
wherein the computer exports the further transformed workstation control data to a control device for control of the workstation by the control device, and
wherein the computer further transforms the transformed task performance data received from the task input device into further transformed task performance data for display by the data feedback device in a readable format; and
a device for remotely providing data responsive to the further transformed task performance data from the workstation.

23. The tele-rehabilitation system of claim 22 wherein the data responsive to the further transformed task performance data comprises data for instructional or shaping messages.

24. The tele-rehabilitation system of claim 22 wherein the task input device receives performance data for an automated CI therapy task that is selected from the group consisting of: Reaching; Peg Moving; Hand Turning; Threading; Tracing; Flipping; Finger Tapping; and Ring-and-Arc Rotation.

25. The tele-rehabilitation system of claim 22 wherein the task input device is selected from the group consisting of: a touch screen monitor that records location of touch by a hand part; a peg board that records peg movement; a handle mounted to a shaft and bearing assembly that records rotation of the handle about an axis through a fixed arc; an assembly of posts that records threading of one or more posts with a string; a touch screen monitor that records location of tracing by a hand part; a camera that records color or pattern changes in a field; a sensor for a finger that records tapping of a finger; and a sensor on an arm that is rotationally secured at one end and where the sensor records rotation of the arm through an arc.

26. The tele-rehabilitation system of claim 22 wherein the computer further transforms the transformed task performance data received from the task input device into autoshaping response data for display in a readable format by the data feedback device.

27. The tele-rehabilitation system of claim 22 wherein workstation control parameter data is suitable for remotely providing therapy via the workstation to a patient who has suffered a stroke, TBI, brain resection, Multiple Sclerosis or SCI.

28. The tele-rehabilitation system of claim 22 wherein workstation control parameter data is suitable for remotely providing therapy via the workstation to a patient for whom continuous one-on-one supervision by a therapist is not practicable or financially feasible.
